(19) United States
(12) Patent Application Publication
(10) Pub. No.: US 2026/0343272 A1
(43) Pub. Date: Oct. 29, 2026

(54) Network Nodes, a Wireless Communications Device and Methods for Configuring the Wireless Communications Device with MDT Measurements in a Wireless Communications Network

(71) Applicant: Telefonaktiebolaget LM Ericsson (publ), Stockholm (SE)

(72) Inventors: Ali Parichehrehteroujeni, Linköping (SE); Panagiotis Saltsidis, Stockholm (SE); Angelo Centonza, Granada (ES); Germán Bassi, Årsta (SE); Sakib Bin Redhwan, Linköping (SE); Luca Lunardi, Genova (IT)

(21) Appl. No.: 19/115,361

(22) PCT Filed: Sep. 22, 2023
(86) PCT No.: PCT/SE2023/050930

§ 371 Date: Mar. 26, 2025

Related U.S. Application Data
(60) Provisional application No. 63/377,209, filed on Sep. 27, 2022.

(51) Int. Cl. H04W 24/08; H04W 76/27

(52) U.S. Cl. CPC H04W 24/08; H04W 76/27

(57) ABSTRACT

A method, performed by a first radio access node, for configuring a wireless communications device with Minimization of Drive Tests, MDT, measurements in a wireless communications network. The method comprises receiving (512) a first MDT configuration for MDT measurements for the wireless communications device. The method further comprises receiving, together with or as part of the first MDT configuration, an indication of MDT continuity for the wireless communications device. The indication of MDT continuity is an indication that continuity of the MDT configuration is requested for the wireless communications device. The method further comprises configuring (516) the wireless communications device to perform MDT measurements based on the first MDT configuration for MDT measurements and based on the indication of MDT continuity for the wireless communications device.

### TECHNICAL FIELD

The embodiments herein relate to network nodes, a wireless communications device and methods for configuring the wireless communications device with MDT measurements in a wireless communications network. A corresponding computer program and a computer program carrier are also disclosed.

### BACKGROUND

In a typical wireless communications network, wireless devices, also known as wireless communications devices, mobile stations, stations (STA) and/or User Equipments (UE), communicate via a Local Area Network such as a Wi-Fi network or a Radio Access Network (RAN) to one or more core networks (CN). The RAN covers a geographical area which is divided into service areas or cell areas, which may also be referred to as a beam or a beam group, with each service area or cell area being served by a radio access node, e.g., a Wi-Fi access point or a radio base station (RBS), which in some networks may also be denoted, for example, a NodeB, eNodeB (eNB), or gNB as denoted in 5G. A service area or cell area is a geographical area where radio coverage is provided by the radio access node. The radio access node communicates over an air interface operating on radio frequencies with the wireless device within range of the radio access node.

Specifications for the Evolved Packet System (EPS), also called a Fourth Generation (4G) network, have been completed within the 3rd Generation Partnership Project (3GPP) and this work continues in the coming 3GPP releases, for example to specify a Fifth Generation (5G) network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio access nodes are directly connected to the EPC core network rather than to RNCs used in 3G networks. In general, in E-UTRAN/LTE the functions of a 3G RNC are distributed between the radio access nodes, e.g., eNodeBs in LTE, and the core network. As such, the RAN of an EPS has an essentially “flat” architecture comprising radio access nodes connected directly to one or more core networks, i.e., they are not connected to RNCs. To compensate for that, the E-UTRAN specification defines a direct interface between the radio access nodes, this interface being denoted the X2 interface.

### Wireless Communication Systems in 3GPP

FIG. 1 illustrates a simplified wireless communication system. Consider the simplified wireless communication system in FIG. 1, with a UE 12, which communicates with one or multiple access nodes 103-104, which in turn is connected to a network node 106. The access nodes 103-104 are part of the radio access network 10.

For wireless communication systems pursuant to 3GPP Evolved Packet System, (EPS), also referred to as Long Term Evolution, LTE, or 4G, standard specifications, such as specified in 3GPP TS 36.300 and related specifications, the access nodes 103-104 correspond typically to Evolved NodeBs (eNBs) and the network node 106 corresponds typically to either a Mobility Management Entity (MME) and/or a Serving Gateway (SGW). The eNB is part of the radio access network 10, which in this case is the E-UTRAN (Evolved Universal Terrestrial Radio Access Network), while the MME and SGW are both part of the EPC (Evolved Packet Core network). The eNBs are inter-connected via the X2 interface, and connected to EPC via the S1 interface, more specifically via S1-C to the MME and S1-U to the SGW.

For wireless communication systems pursuant to 3GPP 5G System, 5GS (also referred to as New Radio, NR, or 5G) standard specifications, such as specified in 3GPP TS 38.300 and related specifications, on the other hand, the access nodes 103-104 correspond typically to 5G NodeBs (gNBs) and the network node 106 corresponds typically to either a Access and Mobility Management Function (AMF) and/or a User Plane Function (UPF). The gNB is part of the radio access network 10, which in this case is the NG-RAN (Next Generation Radio Access Network), while the AMF and UPF are both part of the 5G Core Network (5GC). The gNBs are inter-connected via the Xn interface, and connected to 5GC via the NG interface, more specifically via NG-C to the AMF and NG-U to the UPF.

To support fast mobility between NR and LTE and avoid change of core network, LTE eNBs may also be connected to the 5G-CN via NG-U/NG-C and support the Xn interface. An eNB connected to 5GC is called a next generation eNB (ng-eNB) and is considered part of the NG-RAN. LTE connected to 5GC will not be discussed further in this document; however, it should be noted that most of the solutions/features described for LTE and NR in this document also apply to LTE connected to 5GC. In this document, when the term LTE is used without further specification it refers to LTE-EPC.

### Overview of MDT Framework

### Minimization of Drive Tests (MDT)

MDT is being standardized for NR starting in Rel-16 to reduce the amount of drive tests performed manually. It is a UE assisted framework where network measurements are collected by both IDLE/INACTIVE and RRC Connected UE(s) in order to aid the network in gathering valuable information. It has been specified for both LTE and NR in 3GPP TS 37.320 Radio measurement collection for Minimization of Drive Tests (MDT).

In general, there are two types of MDT measurement logging: Logged MDT for UEs in RRC_IDLE/RRC_INACTIVE state and Immediate MDT for UEs in RRC_CONNECTED state.

The existing trace/MDT framework in 3GPP TS 32.422 Trace control and configuration management enables two methods of activating MDT and collecting data from the UEs:
1) Management based MDT: MDT data is collected from UEs in a specified area. The area is defined as a list of cells or as a list of tracking/routing/location areas. The management based MDT is an enhancement of the management based trace functionality. Management based MDT may be either a logged MDT or Immediate MDT.
2) Signaling based MDT: MDT data is collected from one specific UE. The UE that is participating in the MDT data collection is specified as IMEI (SV) or as IMSI. The signaling based MDT is an enhancement of the signaling based subscriber and equipment trace. A signaling based MDT may be either a logged MDT or Immediate MDT.

Immediate MDT: MDT functionality involving measurements performed by the UE in CONNECTED state and reporting of the measurements to RAN available at the time of reporting condition as well as measurements by the network for MDT purposes.

Logged MDT: MDT functionality involving measurement logging by UE in IDLE mode, INACTIVE state, CELL_PCH, URA_PCH states and CELL_FACH state when second DRX cycle is used (when UE is in UTRA) for reporting to eNB/RNC/gNB at a later point in time, and logging of MBSFN measurements by E-UTRA UE in IDLE and CONNECTED modes.

### MDT Configurations

An example of MDT configuration for NR and for E-UTRAN are provided in the tables below, extracted from 3GPP TS 38.423 v17.1.0, clause 9.2.3.126 and 9.2.3.127.

### 9.2.3.126 MDT Configuration-NR

The IE defines the MDT configuration parameters of NR.

| | | | | Semantics |
|---|---|---|---|---|
| IE/Group Name | Presence | Range | IE type and reference | description |
| MDT Activation | M | | ENUMERATED | |
| | | | (Immediate MDT only, | |
| | | | Logged MDT only, | |
| | | | Immediate MDT and | |
| | | | Trace, . . . ) | |
| CHOICE Area Scope of | O | | | |
| MDT-NR | | | | |
| >Cell based | | | | |
| >>Cell ID List for MDT- | | 1 .. | | |
| NR | | <maxnoofCellIDforMDT> | | |
| >>>NR CGI | M | | 9.2.2.7 | |
| > TA based | | | | |
| >>TA List for MDT | | 1 .. | | |
| | | <maxnoofTAforMDT> | | |
| >>>TAC | M | | OCTET STRING (SIZE | The TAI is derived |
| | | | (3)) | using the current |
| | | | | serving PLMN. |
| > TAI based | | | | |
| >>TAI List for MDT | | 1 .. | | |
| | | <maxnoofTAforMDT> | | |
| >>>TAI | M | | 9.2.3.20 | |
| CHOICE MDT Mode | M | | | |
| >Immediate MDT-NR | | | | |
| >>Measurements to | M | | BITSTRING | Each position in the |
| Activate | | | (SIZE(8)) | bitmap indicates a |
| | | | | MDT measurement, |
| | | | | as defined in TS |
| | | | | 37.320 [43]. |
| | | | | First Bit = M1, |
| | | | | Second Bit= M2, |
| | | | | Fourth Bit = M4, |
| | | | | Fifth Bit = M5, |
| | | | | Sixth Bit = logging |
| | | | | of M1 from event |
| | | | | triggered |
| | | | | measurement |
| | | | | reports according to |
| | | | | existing RRM |
| | | | | configuration, |
| | | | | Seventh Bit = M6, |
| | | | | Eighth Bit = M7. |
| | | | | Value “1” indicates |
| | | | | “activate” and value |
| | | | | “0” indicates “do not |
| | | | | activate”. |
| | | | | This version of the |
| | | | | specification does |
| | | | | not use bits 3. |
| >>M1 Configuration | C-ifM1 | | 9.2.3.128 | |
| >>M4 Configuration | C-ifM4 | | 9.2.3.129 | |
| >>M5 Configuration | C-ifM5 | | 9.2.3.130 | |
| >>MDT Location | O | | BITSTRING(SIZE(8)) | Each position in the |
| Information | | | | bitmap represents |
| | | | | requested location |
| | | | | information as |
| | | | | defined in TS |
| | | | | 37.320 [43]. |
| | | | | First Bit = GNSS |
| | | | | Other bits are |
| | | | | reserved for future |
| | | | | use and are ignored |
| | | | | if received. |
| | | | | Value “1” indicates |
| | | | | “activate” and value |
| | | | | “0” indicates “do not |
| | | | | activate”. |
| | | | | The eNB shall |
| | | | | ignore the first bit |
| | | | | unless the |
| | | | | Measurements to |
| | | | | Activate IE has the |
| | | | | first bit or the sixth |
| | | | | bit set to “1”. |
| >>M6 Configuration | C-ifM6 | | 9.2.3.131 | |
| >>M7 Configuration | C-ifM7 | | 9.2.3.132 | |
| >>Bluetooth | O | | 9.2.3.11 | |
| Measurement | | | | |
| Configuration | | | | |
| >>WLAN Measurement | O | | 9.2.3.12 | |
| Configuration | | | | |
| >>Sensor Measurement | O | | 9.2.3.136 | |
| Configuration | | | | |
| >Logged MDT-NR | | | | |
| >>Logging interval | M | | ENUMERATED | This IE is defined in |
| | | | (ms320, ms640, | TS 38.331 [10]. The |
| | | | ms1280, ms2560, | value “infinity” |
| | | | ms5120, ms10240, | represents one shot |
| | | | ms20480, ms30720, | logging, i.e., only |
| | | | ms40960 and | one log per event in |
| | | | ms61440, infinity) | the logged MDT |
| | | | | report. |
| >>Logging duration | M | | ENUMERATED (10, | This IE is defined in |
| | | | 20, 40, 60, 90, 120) | TS 38.331 [10]. |
| | | | | Unit: [minute]. |
| >>CHOICE Report Type | M | | | |
| >>>Periodical | | | | |
| >>>Event Triggered | | | | |
| >>>>Logged Event | M | | 9.2.3.137 | |
| Trigger Config | | | | |
| >>Bluetooth | O | | 9.2.3.134 | |
| Measurement | | | | |
| Configuration | | | | |
| >>WLAN Measurement | O | | 9.2.3.135 | |
| Configuration | | | | |
| >>Sensor Measurement | O | | 9.2.3.136 | |
| Configuration | | | | |
| >>Area Scope of | O | | 9.2.3.140 | |
| Neighbour Cells | | | | |
| Signaling based MDT PLMN | O | | MDT PLMN List | |
| List | | | 9.2.3.133 | |

| Range bound | Explanation |
|---|---|
| maxnoofCellIDforMDT | Maximum no. of Cell ID subject for MDT |
| | scope. Value is 32 |
| maxnoofTAforMDT | Maximum no. of TA subject for MDT scope. |
| | Value is 8. |

| Condition | Explanation |
|---|---|
| ifM1 | This IE shall be present if the Measurements to Activate IE has |
| | the first bit set to “1”. |
| ifM4 | This IE shall be present if the Measurements to Activate IE has |
| | the fourth bit set to “1”. |
| ifM5 | This IE shall be present if the Measurements to Activate IE has |
| | the fifth bit set to “1”. |
| ifM6 | This IE shall be present if the Measurements to Activate IE has |
| | the seventh bit set to “1”. |
| ifM7 | This IE shall be present if the Measurements to Activate IE has |
| | the eighth bit set to “1”. |

### 9.2.3.127 MDT Configuration-EUTRA

The below IE defines the MDT configuration parameters of EUTRA.

| | | | | Semantics |
|---|---|---|---|---|
| IE/Group Name | Presence | Range | IE type and reference | description |
| MDT Activation | M | | ENUMERATED(Immediate | |
| | | | MDT only, Logged MDT | |
| | | | only, Immediate MDT and | |
| | | | Trace, . . . ) | |
| CHOICE Area Scope of | O | | | |
| MDT-E-UTRA | | | | |
| >Cell based | | | | |
| >>Cell ID List for MDT | | 1 .. | | |
| | | <maxnoofCellIDforMDT> | | |
| >>>NR CGI | M | | 9.2.2.7 | |
| >TA based | | | | |
| >>TA List for MDT | | 1 .. | | |
| | | <maxnoofTAforMDT> | | |
| >>>TAC | M | | OCTET STRING (SIZE (3)) | The TAI is |
| | | | | derived using |
| | | | | the current |
| | | | | serving PLMN. |
| >TAI based | | | | |
| >>TAI List for MDT | | 1 .. | | |
| | | <maxnoofTAforMDT> | | |
| >>>TAI | M | | 9.2.3.20 | |
| MDT Mode E-UTRA | M | | OCTET STRING | MDTMode IE |
| | | | | defined in TS |
| | | | | 36.413 [31]. |
| Signaling based MDT PLMN | O | | MDT PLMN List | |
| List | | | 9.2.3.133 | |

| Range bound | Explanation |
|---|---|
| maxnoofCellIDforMDT | Maximum no. of Cell ID subject for MDT |
| | scope. Value is 32 |
| maxnoofTAforMDT | Maximum no. of TA subject for MDT scope. |
| | Value is 8. |

### Problems with Prior Art Technology

In the framework of MDT, when the UE is in RRC connected state, the network may configure the UE to provide measurements (such as radio measurements and delay measurements) according to an immediate MDT measurement configuration available at the gNB.

In addition, the network may receive from an OAM (via the Core Network or directly) another MDT configuration concerning logged MDT measurements. While the network may configure the same UE selected for immediate MDT with the logged MDT measurement configuration, this is not ensured, and it is left up to implementation.

Additionally, when the UE comes back to the connected state, there is no means for the network to reconfigure the same UE to perform MDT measurements either according to the same immediate MDT measurements or according to a new immediate MDT configuration.

Therefore, the network node, such as the gNB, may not be capable to holistically analyze the measurements provided by the same UE across multiple RRC states. For example, the network cannot pinpoint that although the UE received a very good QoS for a certain time period, the same UE may have experienced a very bad QoS upon coming to the network after a transition from RRC_IDLE mode.

Instead, the network may receive MDT measurements, corresponding to immediate and logged MDT configurations, from different UEs. Such UEs may have different capabilities and different implementations, hence the measurements they collect would be dependent on the nature of the UE itself. As an example, two UEs with different capabilities and different implementation may report different measurements even if measuring the same signal at the same location and time.

The problem that arises with collection of MDT measurements from a variety of UEs with different capabilities and implementation is that the network cannot derive a normalized view of the radio network or of the performance of the network. Instead, the network should first normalize all the collected measurements, for example towards a reference UE implementation, and then analyze the data.

If the MDT data are used for training of an AI/ML model, the issue becomes even more prominent because the training data would need to be “prepared” before they may be used to train a model.

FIG. 2 shows the problem with MDT data collection from multiple UEs. Due to different UE capabilities and implementations of UE1 and UE2, measurements reported for Immediate MDT and Logged MDT may not be consistent. For example, in the same location, UE 1 and UE 2 may report different serving and neighbour cell measurements.

FIG. 2 further shows a timeline. Actions at four times, T1-T4, are presented with the timeline: T1) UE 1 is configured with Immediate MDT, T2) UE 2 is configured with Logged MDT, T3) UE 2 moves to RRC IDLE mode, T4) UE 2 reports logged MDT results, for example after it has moved to RRC CONNECTED mode.

### SUMMARY

As mentioned above, the network cannot derive a normalized view of the radio network or of the performance of the network based on collection of MDT measurements from a variety of UEs with different capabilities and implementation according to prior art.

An object of embodiments herein may be to obviate some of the problems related to MDT measurements, specifically related to MDT measurements from a variety of UEs with different capabilities and implementation.

Embodiments herein disclose how to normalize measurements depending on UE capabilities and implementation.

In the use case discussed herein, it is beneficial to receive MDT based information from a group of UEs selected according to specific criteria. However, it is useful if the UEs selected to report data via MDT continue to report MDT measurements independently of whether they are in Connected, Inactive or Idle state. The latter ensures that measurements reported by the same UE at different connection states are consistent and do not depend on, e.g., UE capabilities, UE implementation, etc. This is a great advantage, as each UE may provide consistent measurements from which a consistent representation of the network may be achieved. Failure to reuse the same UE for MDT collection in different states may lead to an inconsistent set of MDT measurements that depends on UE capabilities and implementation.

According to this concept, once a UE has been selected for immediate MDT measurement reporting, that UE also receives a logged MDT configuration and, with that, the UE may collect and later report measurements logged while in Inactive/Idle. Similarly, once the UE moves back to RRC connected, the UE reports its logged MDT measurements and, with that, the UE reports an indication that MDT measurements should be collected continuously. This enables the network to configure the UE with an immediate MDT configuration.

Such capability enables the same UE to collect measurements across the network when it moves between IDLE/INACTIVE and CONNECTED states and correspondingly enables a much more consistent measurement data set for each chosen individual UE to be fed to the network. Such continuous set of measurements and network information may serve for different purposes, for example it may serve to the training and inference AI/ML functional modules to consistently train a model or to infer from such consistent set of inputs future network events. This concept is described in FIGS. 3a and 3b, where the case of continuous MDT data collection is shown together with a timeline. Actions at four times, T1-T4, are presented with the timeline: T1) UE 1 is configured with Immediate MDT and optionally with Logged MDT, at T1 UE1 may be in RRC CONNECTED mode, T2) UE 2 may be configured with Logged MDT; further, UE1 may report Immediate MDT results, T3) UE 1 moves to RRC IDLE mode, T4) UE 1 may report logged MDT results, for example after it has moved to RRC CONNECTED mode. In FIG. 3b UE 1 may further be configured with Immediate MDT after returning to RRC CONNECTED mode at T4, for example based on the Immediate MDT configuration performed at T1.

To achieve the above proposal, it is necessary to take adequate measures. Currently, the 3GPP standard TS 32.422 prohibits the configuration of immediate MDT and logged MDT within the same trace session. Quoting 3GPP TS 32.422, it reports that “Immediate MDT, Logged MDT and Logged MBSFN MDT measurements shall always be configured as separate trace sessions”. Correspondingly, it may be necessary to use different trace sessions to configure the same UE with Immediate and Logged MDT measurements. A challenge is how to ensure that a UE configured with Logged MDT which subsequently goes to connected, and reports its logs, to be identified as the UE that needs to be configured with immediate MDT measurements and therefore achieve continuous MDT reporting, or similarly how to ensure that the same UE configured with immediate MDT is then selected for logged MDT measurements. To achieve this, the RAN should be able to configure the UE for immediate MDT (with a configuration associated to, e.g., Trace Session 1) and before sending the UE to IDLE the RAN should be able to configure the UE again for logged MDT (with a configuration associated to, e.g., Trace Session 2).

The latter may need some information to be signalled at mobility, so that a target RAN learns that the UE needs to be configured with logged MDT once it is moved to IDLE/INACTIVE.

A summary of the methods proposed herein may be given by following these actions:
1) The RAN may receive an MDT configuration for a specific UE. This configuration contains an indication to configure this UE with MDT measurements in CONNECTED and in IDLE/INACTIVE, e.g., a “Continuous MDT” flag. With this information, the RAN knows that it may, or in some cases has to, configure this UE with MDT measurements in CONNECTED and in IDLE/INACTIVE.

The configuration may also contain information about the type of UEs that may be selected, for example in the form of the UE capabilities a UE needs to have in order to be eligible for MDT measurement configuration. With this information, the RAN knows that it may select UEs with MDT measurements in CONNECTED and in IDLE/INACTIVE using the indicated UE capabilities.
2) The RAN configures the UE with such configurations, which indicate that Continuous MDT is enabled.
3) When the UE moves from Idle mode/Inactive state to Connected mode, the UE indicates to the RAN (either implicitly or explicitly), as part of its logged MDT measurements, that it is configured with Continuous MDT. This allows the RAN to configure the UE with Immediate MDT.
4) During connected mode mobility, the MDT configuration of the UE is passed to the target RAN, such as from a source radio access node to a target radio access node, including an indication of Continuous MDT. The target RAN is therefore able to appropriately configure MDT at the UE on the basis of knowledge that the UE needs to be configured for continuous MDT measurements.
5) If the UE moves to Idle, the serving RAN is aware that the UE needs to be configured with continuous MDT measurements and it is able to configure the UE with logged MDT. As part of the logged MDT configuration the RAN provides to the UE an indication that the MDT configuration is for continuous MDT, hence the UE is able to report such information when it will go back from Idle/Inactive to Connected.

According to an aspect, the object is achieved by a method for configuring a UE with an MDT configuration performed by a first radio access node. In other words, the method is for configuring a wireless communications device with MDT measurements in a wireless communications network.

The method comprises receiving a first MDT configuration for MDT measurements for the wireless communications device.

The method further comprises receiving, together with or as part of the first MDT configuration, an indication of MDT continuity for the wireless communications device. The indication of MDT continuity is an indication that continuity of the MDT configuration is requested for the wireless communications device.

The method further comprises configuring the wireless communications device to perform MDT measurements based on the first MDT configuration for MDT measurements and based on the indication of MDT continuity for the wireless communications device.

According to a further aspect, the object is achieved by a first radio access node configured to perform the method according to the previous aspect.

According to a further aspect, the object is achieved by a method for configuring a wireless communications device, such as a UE, with an MDT configuration, performed by the wireless communications device. In other words, the method is for configuring a wireless communications device with MDT measurements in a wireless communications network.

The method comprises receiving, from a first radio access node, an MDT configuration for MDT measurements for the wireless communications device, including an indication of MDT continuity for the wireless communications device. The indication of MDT continuity is an indication that continuity of the MDT measurements is requested.

The method further comprises performing the MDT measurements based on the MDT configuration including the indication of MDT continuity.

According to a further aspect, the object is achieved by a wireless communications device configured to perform the method according to the previous aspect.

According to a further aspect, the object is achieved by a method for configuring a wireless communications device, such as a UE, with an MDT configuration, performed by a second radio access node. In other words, the method is for configuring a wireless communications device with MDT measurements in a wireless communications network.

The method comprises receiving an indication of MDT continuity for the wireless communications device. The indication of MDT continuity is an indication that continuity of the MDT measurements is requested.

The method further comprises selecting an MDT configuration for MDT measurements to assign to the wireless communications device based on the received indication of MDT continuity.

The method further comprises configuring the wireless communications device (121) to perform MDT measurements based on the selected MDT configuration.

According to a further aspect, the object is achieved by a second radio access node configured to perform the method according to the previous aspect.

According to a further aspect, the object is achieved by a computer program comprising instructions, which when executed by a processor, causes the processor to perform actions according to any of the aspects above.

According to a further aspect, the object is achieved by a carrier comprising the computer program of the aspect above, wherein the carrier is one of an electronic signal, an optical signal, an electromagnetic signal, a magnetic signal, an electric signal, a radio signal, a microwave signal, or a computer-readable storage medium.

Since the wireless communications device is configured to perform MDT measurements based on the indication of MDT continuity, the wireless communications device is able to collect MDT measurements across different RRC states and/or upon mobility of the wireless communications device from the first radio access node to the second radio access node.

Thus, embodiments herein enable the OAM to continuously collect MDT measurements across different RRC states (e.g., Connected, IDLE or Inactive states) for a specific UE or a set of UEs. This allows the network to collect consistent sets of data across different RRC states from a UE with fixed capabilities and implementation. The latter is highly beneficial to gain a normalized and consistent representation of the network configuration and performance as well as for consistent training of AI/ML models and for AI/ML inference based on a set of data normalized against a fixed UE capability set and implementation.

The solution enables the network to monitor the quality of service of the same UE when the UE moves between different RRC states and upon mobility to other radio access nodes.

The solution enables the network to align the Quality of Experience (QoE) or RAN-visible QoE (RVQoE) for a UE when the UE transitions between different RRC states and upon mobility to other radio access nodes.

### BRIEF DESCRIPTION OF THE DRAWINGS

In the figures, features that appear in some embodiments are indicated by dashed lines.

The various aspects of embodiments disclosed herein, including particular features and advantages thereof, will be readily understood from the following detailed description and the accompanying drawings, in which:

FIG. 1 illustrates a simplified wireless communication system,

FIG. 2 illustrates a prior art method for MDT measurements,

FIG. 3a illustrates a method for MDT measurements according to some embodiments herein,

FIG. 3b illustrates a method for MDT measurements according to some further embodiments herein,

FIG. 4 illustrates a wireless communication system according to embodiments herein,

FIG. 5a is a flowchart and illustrates a method, performed by a first radio access node, according to some embodiments herein,

FIG. 5aa is a flowchart and illustrates a further method, performed by a first radio access node, according to some further embodiments herein,

FIG. 5b is a flowchart and illustrates a method, performed by a wireless communications device, according to some embodiments herein,

FIG. 5c is a flowchart and illustrates a method, performed by a second radio access node, according to some embodiments herein,

FIG. 5d is a flowchart and illustrates a method, performed by a network node, according to some embodiments herein,

FIG. 6a is combined flowchart and signaling diagram according to some embodiments herein,

FIG. 6b is a signaling diagram according to some embodiments herein,

FIG. 6c is a block diagram schematically illustrating an OAM/AMF node according to some embodiments herein,

FIG. 7 is a block diagram schematically illustrating a first radio access node according to embodiments herein,

FIG. 8 is a block diagram schematically illustrating a wireless communications device according to embodiments herein,

FIG. 9 is a block diagram schematically illustrating a second radio access node according to embodiments herein,

FIG. 10 schematically illustrates a telecommunication network connected via an intermediate network to a host computer.

FIG. 11 is a generalized block diagram of a host computer communicating via a base station with a user equipment over a partially wireless connection.

FIGS. 12 to 15 are flowcharts illustrating methods implemented in a communication system including a host computer, a base station and a user equipment.

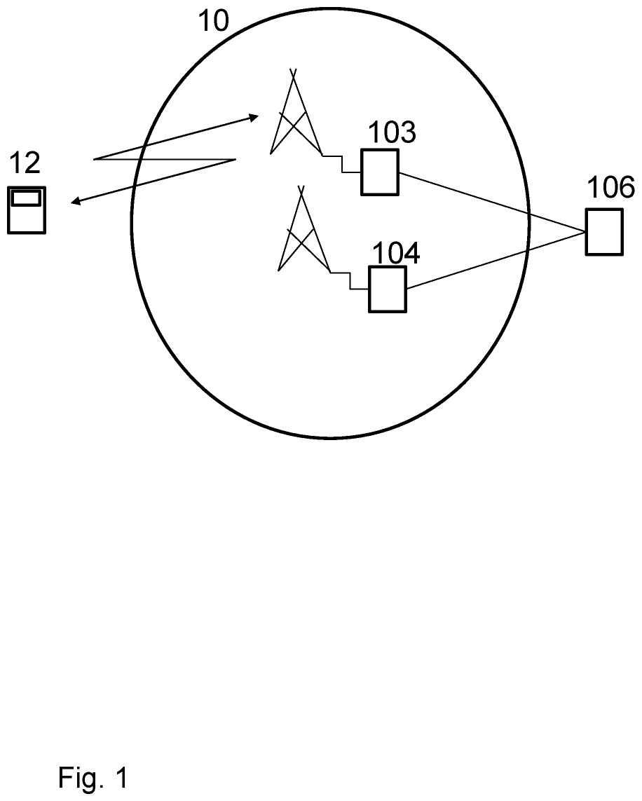

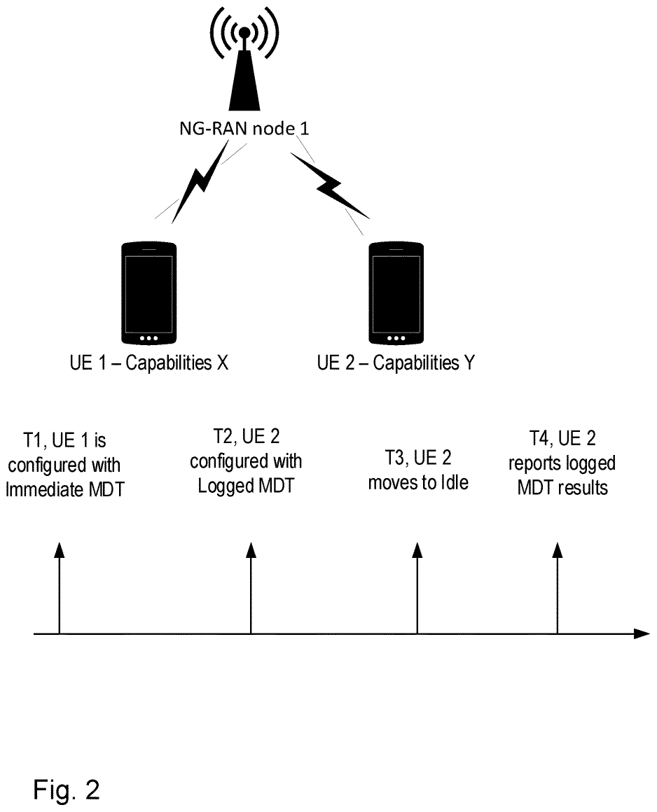

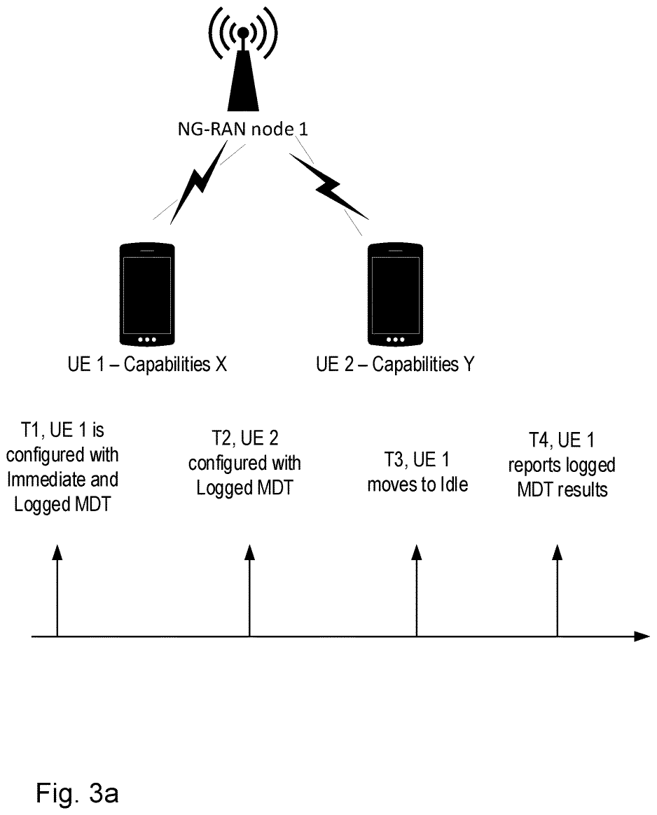

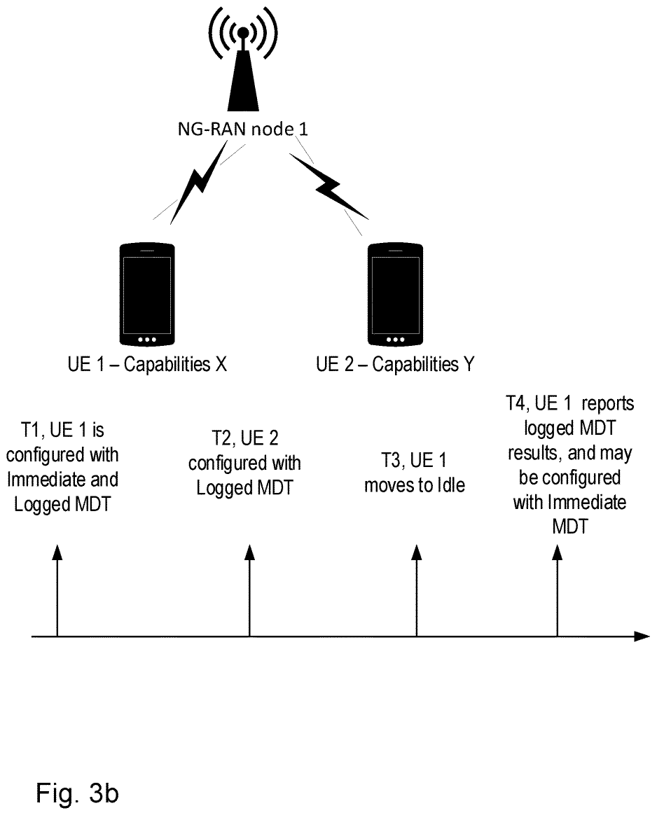

### DETAILED DESCRIPTION

### Disclaimers:

The terms “UE”, “terminal equipment” and “wireless terminal” are used interchangeably.
The terms Measurement Collection Entity (MCE) and Trace Collection Entity (TCE) are used interchangeably.
“The term ‘radio access node’ is used herein to denote (depending on the context) a gNB, eNB, gNB-CU, gNB-CU-CP, eNB-CU, eNB-CU-CP, IAB-donor, IAB-donor-CU, IAB-donor-CU-CP, gNB-CU-UP, eNB-CU-UP, IAB-donor-CU-UP, gNB-DU, IAB-donor-DU, or eNB-DU.”
The term “CU” is used herein as short for “gNB-CU” (and may also refer to an eNB-CU or an IAB-donor-CU″). The term “CU-CP” is used herein as short for “gNB-CU-CP” (and may also refer to an eNB-CU-CP or an IAB-donor-CU-CP). The term “CU-UP” is used herein as short for “gNB-CU-UP” (and may also refer to an eNB-CU-UP or an IAB-donor-CU-UP). The term “DU” is used herein as short for “gNB-DU” (and may also refer to an eNB-DU)).
The terms “MDT configuration” and “MDT measurement configuration” are used interchangeably.
The terms “RVQoE configuration” and “RVQoE measurement configuration” are used interchangeably.
Embodiments herein apply, depending on embodiment, to both signaling- and management-based MDT.
Embodiments herein are primarily described in 5G/NR terms, implying application of embodiments in 5G/NR, but the embodiments are also applicable in e.g., LTE and UMTS (wherein for example in the case of LTE, for instance a gNB would be replaced by an eNB, and an RRCReconfiguration message would be replaced by an RRCConnectionReconfiguration message).
The terms “Trace ID” and “NG-RAN Trace ID” are to a large extent used interchangeably. The “NG-RAN Trace ID” IE used in XnAP and NGAP is often referred to as just “Trace ID”.
For signaling based MDT, the NG-RAN trace ID comprises Trace Reference (TR) and Trace Recording Session Reference (TRSR).

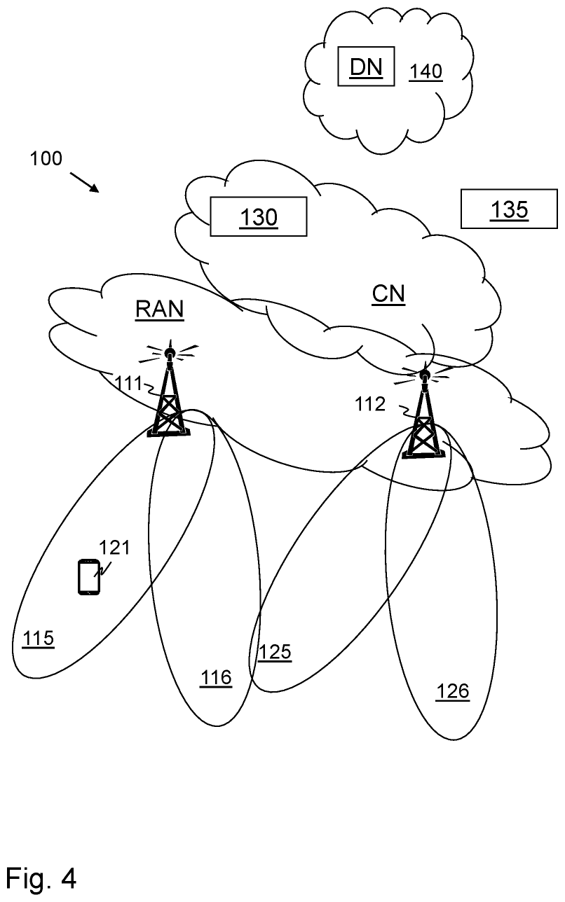

Embodiments herein relate to wireless communications networks in general. FIG. 4 is a schematic overview depicting a wireless communications network 100 wherein embodiments herein may be implemented. The wireless communications network 100 comprises one or more RANs and one or more CNs. The wireless communications network 100 may use a number of different technologies, such as Wi-Fi, Long Term Evolution (LTE), LTE-Advanced, 5G, New Radio (NR), Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

Access nodes operate in the wireless communications network 100 such as a first radio access node 111. The first radio access node 111 provides radio coverage over a geographical area, a service area referred to as a cell 115, which may also be referred to as a beam or a beam group of a first radio access technology (RAT), such as 5G, LTE, Wi-Fi or similar. There may also be further cells for which radio coverage is provided by the first radio access node 111, such as a second cell 116.

There may also be further radio access nodes, such as a second radio access node 112. The second radio access node 112 provides radio coverage over a third cell 125 and/or a fourth cell 126.

In embodiments herein the first radio access node 111 may be referred to as a source radio access node, while the second radio access node 112 may be referred to as a target radio access node. Such terminology may specifically be useful when discussing handover between different radio access nodes.

The first radio access node 111 and the second radio access node 112 may each be a NR-RAN node, transmission and reception point e.g. a base station, a radio access node such as a Wireless Local Area Network (WLAN) access point or an Access Point Station (AP STA), an access controller, a base station, e.g. a radio base station such as a NodeB, an evolved Node B (eNB, eNode B), a gNB, a base transceiver station, a radio remote unit, an Access Point Base Station, a base station router, a transmission arrangement of a radio base station, a stand-alone access point or any other network unit capable of communicating with a wireless device within the service area depending e.g. on the radio access technology and terminology used. The respective first and second radio access node 111, 112 may be referred to as a serving radio access node and communicates with a UE with Downlink (DL) transmissions to the UE and Uplink (UL) transmissions from the UE.

A number of wireless communications devices operate in the wireless communications network 100, such as a wireless communications device 121. The wireless communications device 121 may for example be a UE.

The wireless communications device 121 may be a mobile station, a non-access point (non-AP) STA, a STA, a user equipment and/or a wireless terminal, that communicates via one or more Access Networks (AN), e.g. RAN, e.g. via the first radio access node 111 to one or more core networks (CN) e.g. comprising a CN node 130, for example comprising an Access Management Function (AMF). It should be understood by the skilled in the art that “UE” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell.

The wireless communications network 100 may further comprise an OAM node 135.

Methods herein may in a first aspect be performed by the first radio access node 111, in a second aspect by wireless communications device 121 and in a third aspect by the second radio access node 112. As an alternative, a Distributed Node (DN) and functionality, e.g. comprised in a cloud 140 as shown in FIG. 4, may be used for performing or partly performing the methods.

Embodiments herein will now be described in more detail. Embodiments disclosed herein address a problem of achieving a continuity of MDT measurements across different RRC states and upon mobility of the wireless communications device 121 from one cell to another cell. Embodiments herein comprise enabling a first radio access node, such as the first radio access node 111, which has received at least an immediate and/or a logged MDT measurement configuration, and that received a first indication, indicating that the continuity of the MDT measurement is requested, to configure the wireless communications device 121 with such MDT configuration for continuous measurement collection. Thus, embodiments herein enable the network to continually perform the MDT measurements at the radio access node as well as at the wireless communications device 121 across different RRC states (e.g., IDLE/Inactive or connected states).

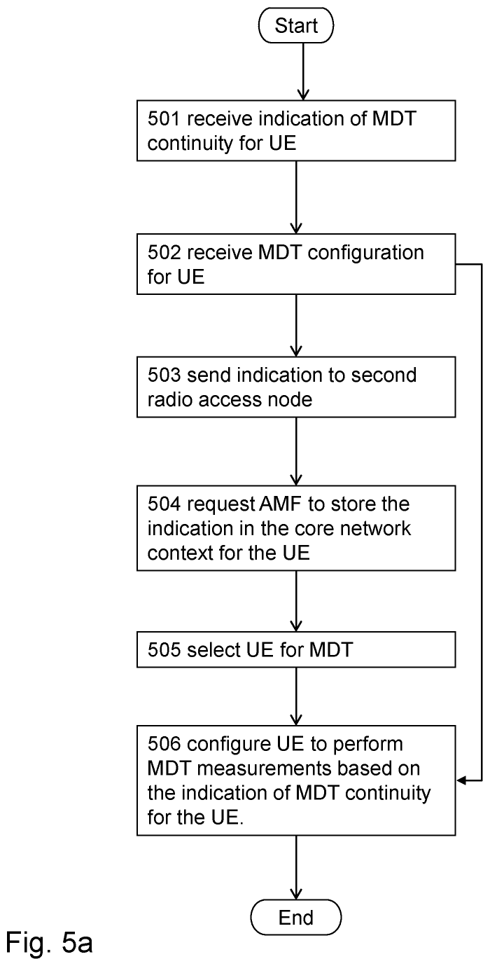

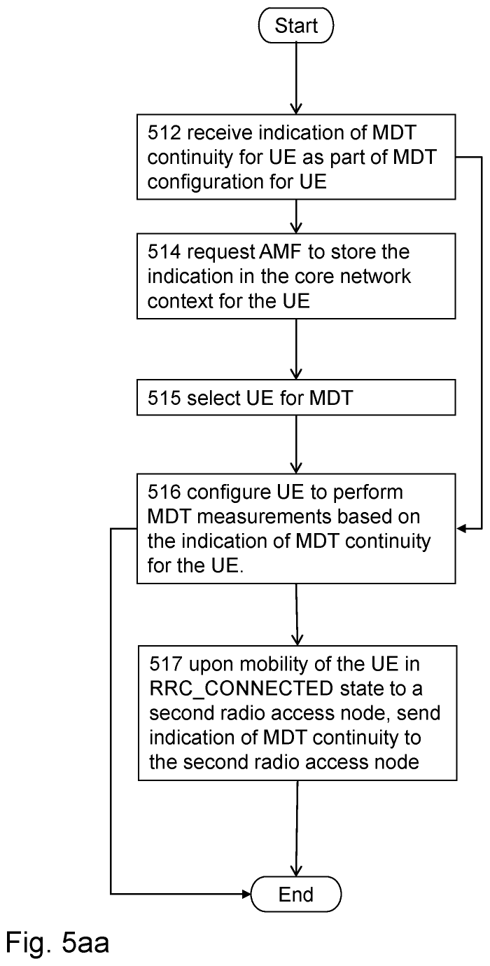

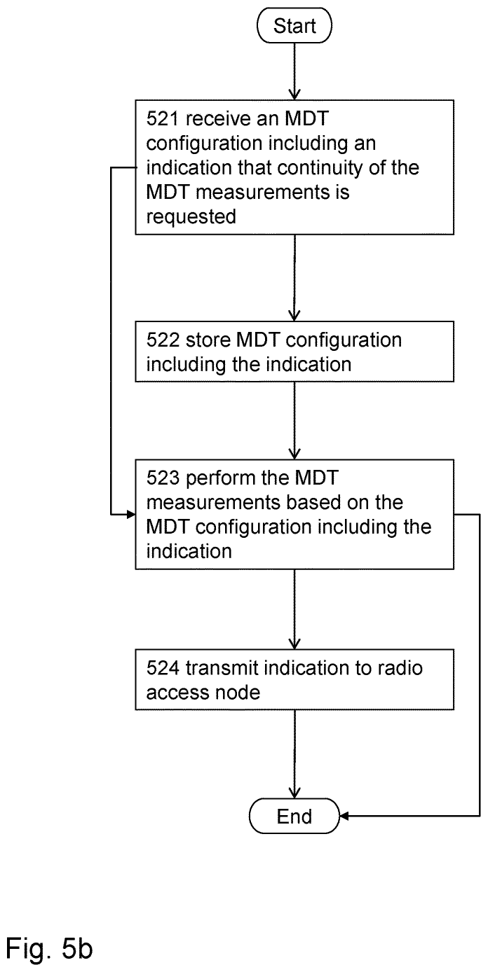

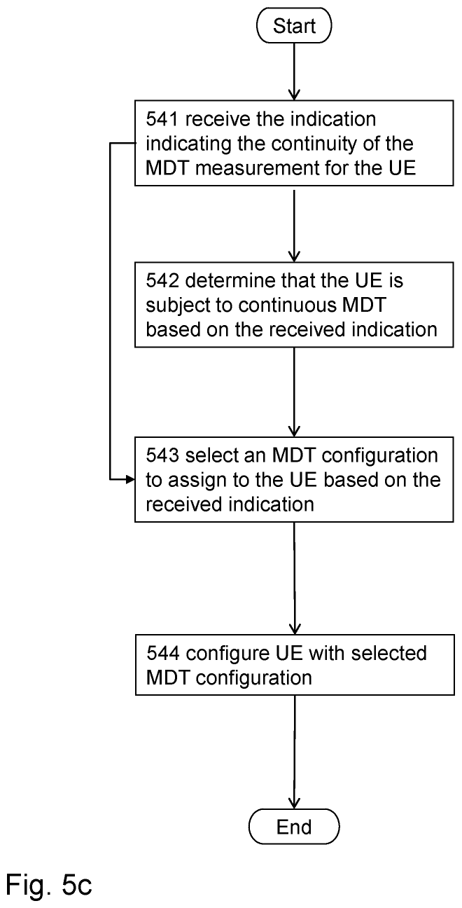

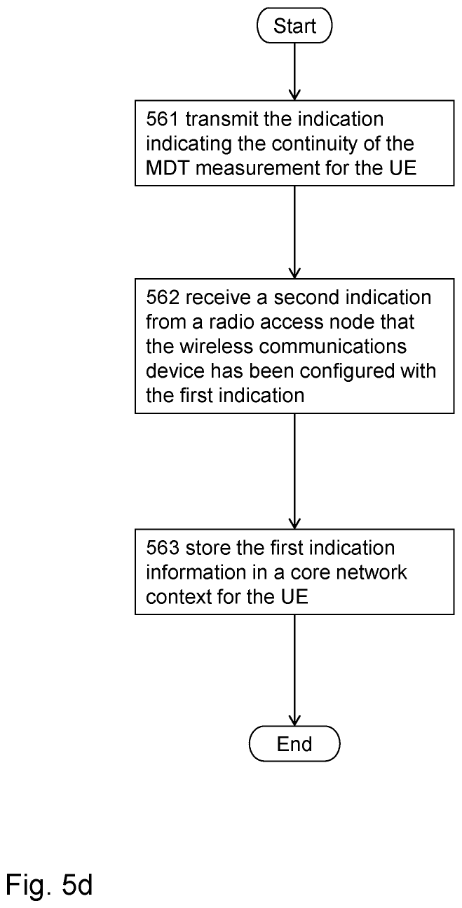

FIG. 5a illustrates example methods performed by the first radio access node 111. The methods of FIG. 5a are methods for configuring the wireless communications device 121 with an MDT configuration.

The methods comprise one or more of the following actions, which actions may be taken in any suitable order.

The first radio access node 111 is configured to communicate with the wireless communications device 121 and with the second radio access node 112.

In Action 501 the first radio access node 111 may receive from a network node, such as the AMF 130 or other radio access nodes, e.g., together with or as part of an MDT configuration, such as an immediate MDT measurement configuration or a logged MDT measurement configuration an indication that continuity of the MDT configuration is requested for the wireless communications device 121. The indication may indicate to configure the wireless communications device 121 with MDT measurements in CONNECTED and in IDLE/INACTIVE, e.g., a “Continuous MDT” flag.

In Action 502 the first radio access node 111 receives MDT configuration(s) from the OAM 135 or the AMF 130 or other radio access nodes. As mentioned above for action 501 the first radio access node 111 may receive the indication that continuity of the MDT configuration is requested for the wireless communications device 121 together with or as part of an MDT configuration. Further, in some embodiments action 501 is part of action 502.

In Action 503, upon mobility of the wireless communications device 121 in RRC_CONNECTED state to another radio access node, such as the second radio access node 112, the first radio access node 111 may send said indication to the other radio access node, e.g., as part of the handover preparation.

In an alternative Action 503 or in an additional part of Action 503, upon reception of a request from another radio access node to retrieve a context of the wireless communications device 121, such as a UE context, for example in case of a UE attempting to resume from RRC_INACTIVE state in a cell served by another radio access node, the first radio access node 111 may send said indication to the other radio access node as part of a procedure to retrieve the context from the first radio access node 111.

In Action 504, in case when the first radio access node 111 receives the indication from OAM (management based immediate MDT), it may ask the AMF to store the indication in the core network context for the wireless communications device 121.

In some other embodiments disclosed herein the first radio access node 111 may receive from OAM or the AMF or other radio access nodes, together with or as part of a signaling based QoE configuration the indication that continuity of the MDT configuration is requested. Also in this case, the same options as described above in connection with the reception of signaling based MDT may be used.

In Action 505 the first radio access node 111 may select the wireless communications device 121 to perform MDT measurements, for example based on the capabilities of the wireless communications device 121.

In Action 506 the first radio access node 111 configures the wireless communications device 121 with the logged MDT configuration with an indication, indicating that the continuity of the MDT measurement upon transition in RRC states or upon mobility. Thus, the first radio access node 111 configures the wireless communications device 121 to perform MDT measurements based on the indication of MDT continuity for the wireless communications device 121. In some embodiments the first radio access node 111 configures the wireless communications device 121 to perform MDT measurements according to the immediate MDT measurements.

In an example embodiment, upon receiving the MDT configuration(s) from OAM/AMF or other radio access nodes, and in some cases upon UE selection (either at the AMF or at the first radio access node 111), the first radio access node 111 configures the wireless communications device 121 to perform MDT measurements according to the immediate MDT measurements. In addition, the first radio access node 111 configures the selected UE with the logged MDT configuration with an indication, indicating that the continuity of the MDT measurement upon transition in RRC states or upon mobility.

FIG. 5aa illustrates some alternative example methods performed by the first radio access node 111. The methods of FIG. 5aa are methods for configuring the wireless communications device 121 with an MDT configuration. In other words, the methods are for configuring the wireless communications device 121 with MDT measurements in the wireless communications network 100.

The methods comprise one or more of the following actions, which actions may be taken in any suitable order.

In Action 512 the first radio access node 111 receives a first MDT configuration for MDT measurements for the wireless communications device 121. The first MDT configuration may be received from the OAM 135 or the AMF 130 or other radio access nodes.

The first radio access node 111 receives together with or as part of the first MDT configuration, the indication of MDT continuity for the wireless communications device 121. As mentioned above, the indication of MDT continuity is an indication that continuity of the MDT configuration is requested for the wireless communications device 121.

The indication of MDT continuity, when configured, tasks the first radio access node 111 to enable continuous MDT measurements across different RRC states and/or upon mobility of the wireless communications device 121 from the first radio access node 111 to the second radio access node 112.

The indication of MDT continuity may be a flag. An example of a flag is given below when describing possible changes to the XnAP interface in order to signal the indication of MDT continuity. For the Xn AP interface a Continuous MDT IE, which configures continuous MDT operation across RRC states, may be defined as ENUMERATED (true, . . . ).

In some other embodiments the indication of MDT continuity may be a TR identifier or a TRSR identifier or both associated to an MDT configuration, such as the first or second MDT configuration, or a Trace ID value.

In some embodiments herein the indication of MDT continuity is received from any one of the OAM node 135, the network node 130 implementing the AMF or another radio access node, such as the second radio access node 112.

The indication of MDT continuity may include any one or more of:
a. an area in which the continuity of the MDT measurements is requested and valid when the wireless communications device 121 is camping in the area;
b. a time period during which continuity of the MDT measurements is valid;
c. the second MDT configuration to be used later;
d. a Quality of Experience, QoE, Reference ID or a Recording Session ID, indicating that continuity of the MDT measurements is required for a specific QoE measurement collection;
e. an indication of alignment between QoE and MDT, indicating that continuity of the MDT measurements is required for the purpose of aligning QoE measurements and MDT measurements;
f. a flag indicating that continuity of the MDT is for collecting data for machine learning;
g. one or more types of traffic or service for which the continuity of the MDT measurements is valid;
h. one or more network optimization processes or machine learning use cases, wherein the continuity of the MDT measurements is valid as long as the wireless communications device 121 is camping on or being served by cells affected by the indicated network optimization processes or machine learning use cases; or
i. an extended continuity value X associated to each or some of the one or more network optimization processes or machine learning use cases, wherein the continuity of the MDT measurements is still valid in cells not affected by the indicated network optimization processes or AI/ML use cases as long as the wireless communications device 121 has not been served by more than X consecutive not-affected cells.

In some embodiments the indication of MDT continuity is an identifier that identifies that an MDT process is continuous MDT and that the MDT configuration for the wireless communications device 121 belongs to a specific MDT configuration class identified by the identifier.

In some embodiments herein the first radio access node 111 receives a second MDT configuration for second MDT measurements. The second MDT configuration may be received while the first MDT configuration is valid. In some embodiments the second MDT configuration is received together with the first MDT configuration.

The first MDT configuration may be an immediate MDT configuration and the second MDT configuration may be a logged MDT configuration. In some other embodiments the first MDT configuration is a logged MDT configuration and the second MDT configuration is an immediate MDT configuration.

Action 512 is related to action 501 and 502 above.

In Action 514 in case when the first radio access node 111 receives the indication from OAM management based immediate MDT, it may ask the AMF to store the indication in the core network context for the wireless communications device 121.

Action 514 is related to action 504 above.

In Action 515 the first radio access node 111 may select the wireless communications device 121 for continuous MDT measurements based on capabilities of the wireless communications device 121 for MDT measurements.

By selecting the wireless communications device 121 for continuous MDT measurements based on the capabilities of the wireless communications device 121 for MDT measurements, the selection of specific UEs with the indicated capabilities for the continuous MDT measurement collection process is possible. This may make it easier to obtain a normalized view of the radio network or of the performance of the network based on the collected MDT measurements.

Action 515 is related to action 505 above.

In Action 516 the first radio access node 111 configures the wireless communications device 121 to perform MDT measurements based on the first MDT configuration for MDT measurements and based on the indication of MDT continuity for the wireless communications device 121. In some embodiments herein the first radio access node 111 further configures the wireless communications device 121 to perform MDT measurements based on the second MDT configuration for MDT measurements and based on the indication of MDT continuity for the wireless communications device 121.

Action 516 is related to action 506 above.

In Action 517 the first radio access node 111, upon mobility of the wireless communications device 121 in RRC_CONNECTED state, may send the indication of MDT continuity for the wireless communications device 121 to the second radio access node 112, e.g., as part of a handover preparation. For example, upon reception of a request from the second radio access node 112 to retrieve a context of the wireless communications device 121, the first radio access node 111 may send the indication of MDT continuity for the wireless communications device 121 to the second radio access node 112 as part of a procedure to retrieve the context of the wireless communications device 121 from the first radio access node 111. The context of the wireless communications device 121 may be a UE context.

Action 517 is related to action 503 above.

FIG. 5b illustrates example methods performed by the wireless communications device 121.

The methods of FIG. 5b are methods for configuring a UE with an MDT configuration. In other words, the methods are for configuring the wireless communications device 121 with MDT measurements in the wireless communications network 100.

The methods comprise one or more of the following actions, which actions may be taken in any suitable order.

The wireless communications device 121 is configured to communicate with each of the first and second radio access nodes 111, 112.

In Action 521, the wireless communications device 121 receives an MDT configuration for MDT measurements for the wireless communications device 121 including an indication of MDT continuity for the wireless communications device 121. The indication of MDT continuity is an indication that continuity of the MDT measurements is requested.

The indication of MDT continuity may include any one or more of:
an area in which the continuity of the MDT measurements is requested and valid when the wireless communications device 121 is camping in the area, and
a time period during which continuity of the MDT measurements is valid, and wherein transmitting 524 the received indication of continuous MDT measurements to the first radio access node 111 or the second radio access node 112 is performed if the wireless communications device 121 is camping in the area and/or if a time is within the time period during which continuity of the MDT measurements is valid.

In some embodiments herein the received MDT configuration is a logged MDT configuration, and then the MDT measurements are performed in an RRC IDLE or inactive state of the wireless communications device 121. In other words, the MDT measurements may be performed while the wireless communications device 121 is in an RRC IDLE or inactive state.

In Action 522, the wireless communications device 121 may store the configuration including the indication.

In Action 523, the wireless communications device 121 performs the MDT measurements based on the MDT configuration including the indication that continuity of the MDT measurements is requested.

When the wireless communications device 121 moves to RRC idle, the serving radio access node, such as the first radio access node 111, removes the context of the wireless communications device 121, such as the UE context. When the wireless communications device 121 returns to RRC connected state the radio access node serving the cell to which the wireless communications device 121 connects does not have access to the context of the wireless communications device 121. For example, if the wireless communications device 121 stays in the same cell or moves to another cell of the same radio access node, then the radio access node does not have access to the context the wireless communications device 121. In order to solve this problem, the wireless communications device 121 may signal the indication of MDT continuity to the serving radio access node when going to RRC connected.

Thus, in Action 524, the wireless communications device 121 may transmit the received indication of continuous MDT measurements to a serving radio access node, such as the first radio access node 111 or the second radio access node 112. The indication of continuous MDT measurements may be transmitted upon connection to a cell after the wireless communications device 121 has been in an RRC IDLE state. In other words, transmitting the received indication of MDT continuity to the first radio access node 111 or the second radio access node 112 may be performed upon transitioning back to an RRC connected state. The indication may be sent to a radio access node that is serving the cell to which the wireless communications device 121 connects. For example, the wireless communications device 121 transmits the received indication of MDT continuity to the first radio access node 111 upon connection to a cell 115, 116 served by the first radio access node 111, or to the second radio access node 112 upon connection to a further cell 125, 126 served by the second radio access node 112. The transmitted indication of MDT continuity may be comprised in an RRC message, such as an RRCSetupComplete message, an RRCConnectionSetupComplete message or a UEAssistanceInformation message.

In one embodiment, upon receiving a logged MDT configuration including an indication that continuity of the MDT measurements is requested, the wireless communications device 121 stores the configuration including the indication and upon transition to the RRC IDLE/Inactive states, the wireless communications device 121 starts the measurements. Upon transition back to the RRC connected state, the wireless communications device 121 indicates the received indication of continuous MDT measurements to the second radio access node 112. The latter may be done either together with the reporting of Logged MDT measurements or separately.

In a different embodiment, while in RRC_CONNECTED state, and possibly independently of receiving a logged MDT configuration (e.g., as part of configuration of radio measurements), or during the transition from RRC_IDLE/RRC_INACTIVE state to RRC_CONNECTED state (e.g., in a RRCResume message or in an RRCSetup message or in an RRCReestablishment message), the wireless communications device 121 receives an indication indicating that continuity of MDT measurements is requested, and the wireless communications device 121 stores the indication. At transition from RRC_IDLE/RRC_INACTIVE state to RRC_CONNECTED state, the wireless communications device 121 may continue MDT measurements according to a logged MDT configuration if available.

FIG. 5c illustrates example methods performed by the second radio access node 112. However, the methods illustrated by FIG. 5c are also applicable to the first radio access node 111. For example, in a scenario disclosed herein, the wireless communications device 121 moves between different cells served by the first radio access node 111 and also transitions between different RRC states during a time period when it moves between different cells served by the first radio access node 111. In some embodiments herein the wireless communications device 121 is first in RRC connected mode in the first cell 115, transitions to RRC IDLE mode and then transitions back to RRC connected mode in another cell, such as the second cell 116, served by the first radio access node 111. Thus, actions 541-543 described below as performed by the second radio access node 112 may also be performed by the first radio access node 111. Alternatively, the first radio access node 111 may be referred to as the second radio access node after the wireless communications device 121 has transitioned back to RRC connected mode. The methods of FIG. 5c are methods for configuring a UE with an MDT configuration. In other words, the methods are for configuring the wireless communications device 121 with MDT measurements in the wireless communications network 100.

The methods comprise one or more of the following actions, which actions may be taken in any suitable order.

The second radio access node 112 is configured to communicate with the wireless communications device 121 and with the first radio access node 111.

In Action 541 the second radio access node 112 receives the indication indicating the continuity of the MDT measurement for the wireless communications device 121.

In some embodiments the indication of MDT continuity is received upon handover preparation of the wireless communications device 121 from the first radio access node 111 or upon retrieval of the context of the wireless communications device 121.

In Action 542 the second radio access node 112 determines that the wireless communications device 121 is subject to continuous MDT based on the received indication.

In Action 543 the second radio access node 112 selects an MDT configuration for MDT measurements to assign to the wireless communications device 121 based on the received indication of MDT continuity.

In some embodiments herein the indication of MDT continuity comprises a first identifier and then selecting the MDT configuration based on the received indication of MDT continuity comprises comparing the first identifier with a second identifier contained in an MDT configuration stored in the second radio access node 112 and selecting the MDT configuration containing the second identifier that matches the first identifier.

In some embodiments herein the method further comprises determining that the indication of MDT continuity indicates an MDT configuration that is not available at the second radio access node 112 and requesting another radio access node 111 and/or an OAM node 135 or the node 130 implementing an AMF for the MDT configuration that is determined to be missing at the second radio access node 112. The request includes an indication indicating the missing MDT configuration.

In an example embodiment, upon receiving an indication from the wireless communications device 121 moving from RRC Idle/Inactive to RRC Connected or from the first radio access node 111 in case of UE mobility towards the second radio access node 112, indicating the continuity of the MDT measurement for the wireless communications device 121, the second radio access node 112 determines that the wireless communications device 121 is subject to continuous MDT and it selects a configuration to assign to the wireless communications device 121. The second radio access node 112 may select the configuration to assign to the wireless communications device 121 among a plurality of selectable configurations.

In Action 544 the second radio access node 112 may configure the wireless communications device 121 to perform MDT measurements based on the selected MDT configuration.

Upon receiving MDT measurement results from the wireless communications device 121 the second radio access node 112 collects the MDT measurements and forwards them to the TCE. Receiving MDT measurement results from the wireless communications device 121 may be performed both before and after the second radio access node 112 configures the wireless communications device 121 to perform MDT measurements based on the selected MDT configuration. Some examples of this are given below.
Mobility of the wireless communications device 121 in connected mode between the first radio access node 111 and the second radio access node 112. In this case, when the wireless communications device 121 connects to the second radio access node 112, the second radio access node 112 may first configure immediate MDT measurements and then it may collect the measurements from the wireless communications device 121.
Mobility of the wireless communications device 121 in idle mode between the first radio access node 111 and second radio access node 112. In this case, the wireless communications device 121 has been collecting logged MDT measurements during the time in idle mode. When the wireless communications device 121 connects to second radio access node 112, the wireless communications device 121 signals the availability of the logged MDT measurements. After this, there are several alternatives:
   The second radio access node 112 may firstly request and collect the logged MDT measurements, secondly configure immediate MDT measurements, and then collect the immediate MDT measurements.
   The second radio access node 112 may alternatively firstly configure immediate MDT measurements, secondly request the logged MDT measurements, and then collect the immediate MDT measurements.

If the second radio access node 112 configures logged MDT measurements, it should first request and collect the old logged MDT measurements. Otherwise, those measurements will be erased by the wireless communications device 121.

FIG. 5d illustrates example methods performed by a network node, such as the CN node 130 or the OAM node 135. The methods of FIG. 5d are methods for configuring the wireless communications device 121 with an MDT configuration. In other words, the methods are for configuring the wireless communications device 121 with MDT measurements in the wireless communications network 100.

The methods comprise one or more of the following actions, which actions may be taken in any suitable order.

In Action 561 the network node 130, 135 transmits a first MDT configuration for MDT measurements for the wireless communications device 121 to a radio access node 111. Further, the network node 130, 135 transmits, together with or as part of the first MDT configuration, a first indication that continuity of the MDT configuration is requested for the wireless communications device 121.

In Action 562 the network node 130, 135 may receive a second indication from the radio access node 111, 112 that the wireless communications device 121 has been configured with the first indication.

In some embodiments herein in Action 563 the network node 130, 135 stores the first indication information in a core network context for the wireless communications device 121, such as an AMF UE context.

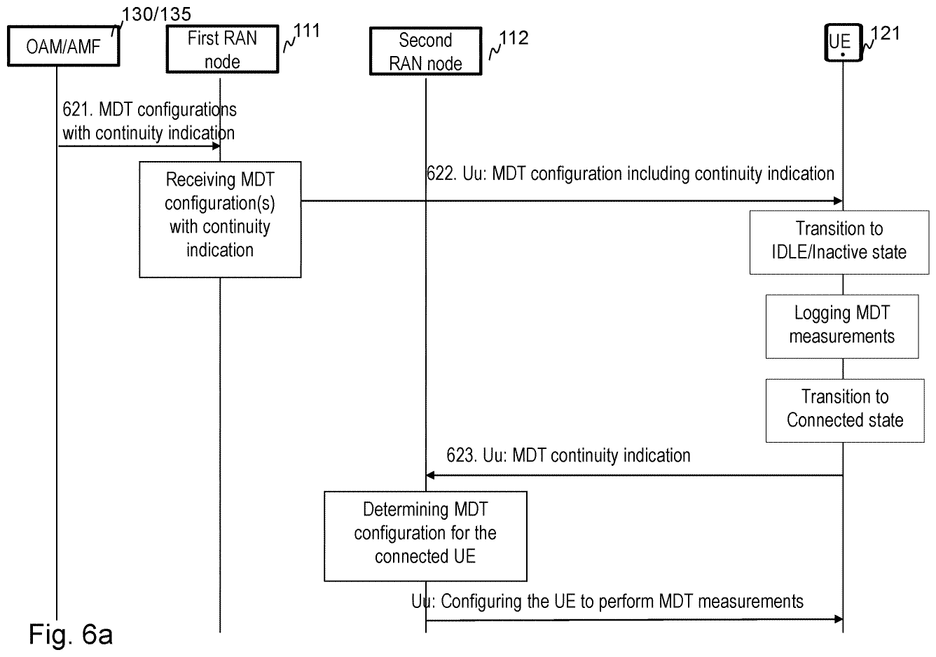

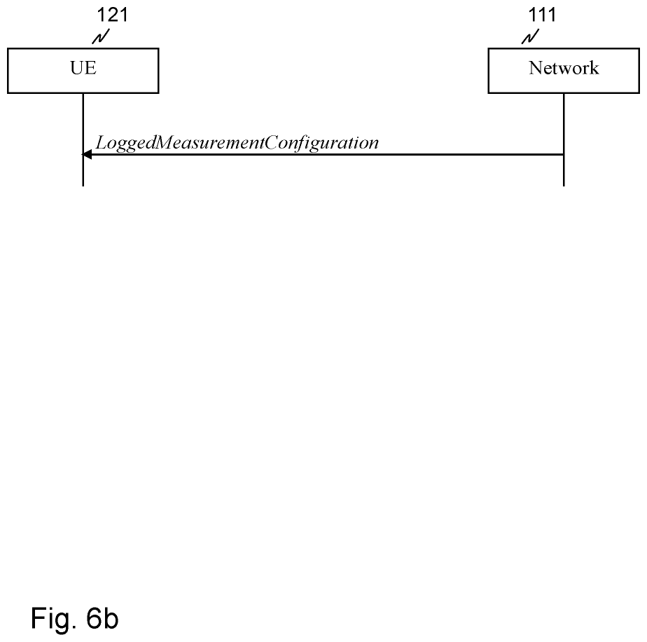

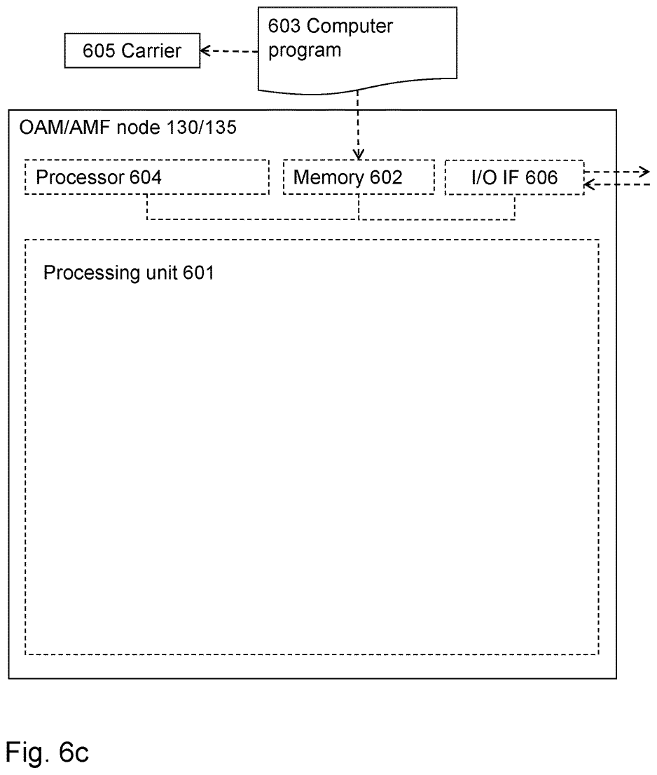

FIG. 6a is a combined signaling diagram and flow chart and illustrates an example implementation of a method for continuity of the MDT measurements across different RRC states and upon mobility between radio access nodes. The method may comprise the following signals:

A first signal 621 from the OAM node 135 or the AMF node 130 to the first radio access node 111 including MDT configuration(s) including an indication of MDT measurement continuity;

A second signal 622 sent from the first radio access node to the wireless communications device 121 including the MDT configuration as well as the MDT continuity indication;

Transition of the wireless communications device 121 between different RRC states and coming back to the connected state either in a cell served by the first radio access node 111 or the second radio access node 112;

A third signal 623 including the MDT continuity indication from the wireless communications device 121 to the radio access node owning the new serving cell (here the second radio access node 112).

Determining the MDT configuration based on the received MDT continuity indication. For example, in some embodiments herein the indication of MDT continuity comprises a first identifier and then determining the MDT configuration based on the received indication of MDT continuity may comprise comparing the first identifier with a second identifier contained in an MDT configuration stored in the radio access node owning the new serving cell and determining the MDT configuration to be the MDT configuration containing the second identifier that matches the first identifier.

Performing the determined MDT configuration and configuring the wireless communications device 121 to perform the MDT measurements based on the determined MDT configuration.

The second radio access node may receive from the first radio access node, an indication of MDT continuity for the wireless communications device 121 upon handover preparation (e.g., as part of an Xn HANDOVER REQUEST message), or upon UE context retrieval (e.g., as part of a RETRIEVE UE CONTEXT RESPONSE message).

The second radio access node may receive from the first radio access node 111, upon retrieval of a UE context from the first radio access node 111, e.g., at resume of the wireless communications device 121 to the second radio access node 112, an indication of MDT continuity for the wireless communications device 121.

The second radio access node 112 may receive from the AMF upon retrieval of the UE context from the AMF, an indication of MDT continuity for the wireless communications device 121 (e.g., as part of INITIAL CONTEXT SETUP REQUEST message).

In the following the first MDT configuration in a non-limiting example refers to an immediate MDT configuration. The second MDT configuration in a non-limiting example refers to a logged MDT configuration. The first indication is a piece of information provided/configured by the OAM/AMF or other radio access nodes requesting the radio access node to continue performing MDT measurements when the wireless communications device 121 transits between different RRC states (e.g., transition from IDLE mode to connected mode)

### DETAILED EMBODIMENTS

### First Radio Access Node Embodiments (Group a Embodiments)

The solution proposed by embodiments disclosed herein comprises a method performed by the first radio access node 111. The method is for configuring the wireless communications device 121, such as a UE, with MDT measurements. In other words, the method is for configuring the wireless communications device 121 to perform the MDT measurements. Such a configuration may also be referred to as an MDT configuration. The configuration may be stored in the wireless communications device 121. The method comprises receiving one or more MDT configuration(s), e.g., first and second MDT configurations, including the first indication (MDT continuity indication) from OAM or AMF or from another network node. The first indication, when configured, tasks the first radio access node 111 to enable continuous MDT measurements across different RRC states and/or upon mobility from first radio access node 111 to the second radio access node 112. The first MDT continuity indication may be received in several ways:
Upon mobility of the wireless communications device 121 in RRC_CONNECTED state to the second radio access node 112, the first radio access node 111 sends said indication to the second radio access node 112 as part of the handover preparation.
Upon receiving the request from the second radio access node 112 to retrieve the context of the wireless communications device 121, for example in case of the wireless communications device 121 attempting to resume from RRC_INACTIVE state in the second radio access node 112, the first radio access node 111 may send said indication to the second radio access node 112 as part of a procedure to retrieve the context, such as the UE context, from the first radio access node 111.

The method further comprises configuring the wireless communications device 121 to perform MDT measurements based on the first MDT configuration and collecting the MDT measurements from the wireless communications device 121 and from the radio access node as per the first MDT configuration and forwarding the MDT measurements to the TCE.

The method further comprises configuring the wireless communications device 121 with the second MDT configuration and the first indication that indicates the continuity of performing MDT measurements. Different embodiments of the first indication are given in the below list:
In an embodiment the first indication is the TR associated to the first MDT configuration. Namely, the indication of continuous MDT measurements is implicit, and it is achieved via the usage of specific TR identifiers.
In another embodiment the first indication is the TRSR associated to the first MDT configuration. Namely, the indication of continuous MDT measurements is implicit, and it is achieved via the usage of specific Trace Recording Session Reference identifiers.
In yet another embodiment the first indication is a combination of the two methods above, hence it consists of the TR and TRSR associated to the first MDT configuration.
In another embodiment the first indication is the Trace ID generated and sent by AMF to the first radio access node 111 (e.g., in case of signaling based MDT configuration). Namely, the indication of continuous MDT measurements is implicit, and it is achieved via the usage of specific Trace ID values.
In another embodiment the first indication may be a list of TR and TRSR associated to more than one MDT configuration.
In another embodiment the first indication includes an area scope in which the continuity of the MDT measurement is requested and valid when wireless communications device 121 is camping in the configured area. The area scope may include PLMN Identity, TAC, cell global identity or physical cell identity or any combination of them.
In another embodiment the first indication includes a timer value indicating the time period where continuity of the MDT measurement is valid/applicable.
In another embodiment the first indication is a UE identifier associated to the first MDT configuration. Namely, the indication of continuous MDT measurements is implicit, and it is achieved via the usage of a RAN UE ID or any other UE identifier referencing the wireless communications device 121 or wireless communications devices that are satisfying the MDT configuration selection rules.
In another embodiment the first indication is a flag indicating that continuity of the MDT measurement is required.
In another embodiment the first indication includes a second MDT configuration (e.g., logged MDT configuration) to be used later for continuity of the measurements.
In another embodiment the first indication includes a QoE Reference ID or a Recording Session ID, indicating that continuity of the MDT measurements is required for a specific QoE measurement collection.
In another embodiment the first indication includes an indication of alignment between QoE and MDT, indicating that continuity of the MDT measurements is required for the purpose of aligning/correlating QoE measurements and MDT measurements (where QoE collection type may be signaling based QoE, or management based QoE).
In another embodiment the first indication includes a flag indicating that continuity of the MDT is for collecting training/input/output/feedback data for AI/ML (or for an AI/ML use case, or for an AI/ML model).
In another embodiment, the first indication includes one or more types of traffic or service, e.g., the continuity of the MDT measurements is valid as long as the wireless communications device 121 is performing video streaming, web browsing, etc.
In another embodiment, the first indication includes one or more network optimization processes or AI/ML use cases. The continuity of the MDT measurements is valid as long as the wireless communications device 121 is camping on or being served by cells affected by the indicated network optimization processes or AI/ML use cases.
In a related embodiment, the first indication includes an “extended continuity” value X associated to each or some of the one or more network optimization processes or AI/ML use cases. The continuity of the MDT measurements is still valid in cells not affected by the indicated network optimization processes or AI/ML use cases as long as the wireless communications device 121 has not been served by more than X consecutive not-affected cells. For example, assume the wireless communications device 121 has a first indication for continuity of MDT related to Network Energy Efficiency with X=1, and the wireless communications device 121 connects successively to cells 1, 2, 3, 4, and 5, where only cells 1 and 3 are affected by Network Energy Efficiency; in this case, the MDT measurements are continuously collected until the wireless communications device 121 connects to cell 5.
In another embodiment the first indication is an identifier that identifies that the MDT process is continuous MDT and that the MDT configuration for the wireless communications device 121 belongs to a specific MDT configuration class identified by the identifier. This type of first indication may be used to enable the radio access node to identify the MDT configuration that needs to be selected and configured at the wireless communications device 121, assuming that the MDT configurations received by the radio access node (from OAM) include the same identifier and therefore may be classified by means of such identifier.

The first radio access node 111 may receive from OAM/AMF or other radio access nodes, together with or as part of a signaling based QoE configuration an indication that continuity of the MDT configuration is requested. Also in this case, the same options as described above in connection with the reception of signaling based MDT may be used.

In a separate embodiment, where the first radio access node 111 has only received the first MDT configuration and the first indication, it may configure the wireless communications device 121 to store the first indication while the wireless communications device 121 is being released from the network (wireless communications device 121 is transitioning to RRC_IDLE state). The first radio access node may, for example, use the RRCRelease message to configure the wireless communications device 121 to store the first indication while the wireless communications device 121 is being released from the network.

In a separate embodiment, where the first MDT configuration received in the radio access node is a management-based MDT configuration (from the OAM) and the radio access node also receives the first indication, it indicates to AMF to store the first indication in the UE context of the AMF.

An example of how the first indication may be received by the first radio access node 111 is shown below, where the MDT Configuration-NR transmitted over the NG interface to the RAN is represented, with the addition of the flag indicating that the configuration is for continuous MDT.

### MDT Configuration-NR

The IE defines the MDT configuration parameters of NR.

reference

| | | | IE type and | Semantics |
|---|---|---|---|---|
| IE/Group Name | Presence | Range | reference | description |
| MDT Activation | M | | ENUMERATED | |
| | | | (Immediate MDT | |
| | | | only, Logged MDT | |
| | | | only, Immediate | |
| | | | MDT and Trace, . . . ) | |
| CHOICE Area Scope of MDT | M | | | |
| >Cell based | | | | |
| >>Cell ID List for MDT | | 1 .. | | |
| | | <maxnoofCellIDforMDT> | | |
| >>>NR CGI | M | | 9.3.1.7 | |
| >TA based | | | | |
| >>TA List for MDT | | 1 .. | | |
| | | <maxnoofTAforMDT> | | |
| >>>TAC | M | | 9.3.3.10 | The TAI is derived |
| | | | | using the current |
| | | | | serving PLMN. |
| >PLMN wide | | | NULL | |
| >TAI based | | | | |
| >>TAI List for MDT | | 1 .. | | |
| | | <maxnoofTAforMDT> | | |
| >>>TAI | M | | | |
| CHOICE MDT Mode | M | | | |
| >Immediate MDT | | | | |
| >>Measurements to | M | | BITSTRING | Each position in the |
| Activate | | | (SIZE(8)) | bitmap indicates a |
| | | | | MDT measurement, |
| | | | | as defined in TS |
| | | | | 37.320 [41]. |
| | | | | First Bit = M1, |
| | | | | Second Bit= M2, |
| | | | | Third Bit = M4, |
| | | | | Fourth Bit = M5, |
| | | | | Fifth Bit = M6, |
| | | | | Sixth Bit = M7, |
| | | | | Seventh Bit = logging |
| | | | | of M1 from event |
| | | | | triggered |
| | | | | measurement reports |
| | | | | according to existing |
| | | | | RRM configuration, |
| | | | | other bits reserved |
| | | | | for future use. |
| | | | | Value “1” indicates |
| | | | | “activate” and value |
| | | | | “0” indicates “do not |
| | | | | activate”. |
| >M1 Configuration | C-ifM1 | | 9.3.1.171 | |
| >>M4 Configuration | C-ifM4 | | 9.3.1.172 | |
| >>M5 Configuration | C-ifM5 | | 9.3.1.173 | |
| >>M6 Configuration | C-ifM6 | | 9.3.1.174 | |
| >>M7 Configuration | C-ifM7 | | 9.3.1.175 | |
| >>Bluetooth Measurement | O | | 9.3.1.177 | |
| Configuration | | | | |
| >>WLAN Measurement | O | | 9.3.1.178 | |
| Configuration | | | | |
| >>MDT Location | O | | 9.3.1.176 | |
| Information | | | | |
| >>Sensor Measurement | O | | 9.3.1.179 | |
| Configuration | | | | |
| >Logged MDT | | | | |
| >>Logging interval | M | | ENUMERATED | This IE is defined in |
| | | | (320 ms, 640 ms, | TS 38.331 [18]. |
| | | | 1280 ms, 2560 ms, | |
| | | | 5120 ms, 10240 ms, | |
| | | | 20480 ms, 30720 ms, | |
| | | | 40960 ms, 61440 ms, | |
| | | | infinity, . . . ) | |
| >>Logging duration | M | | ENUMERATED | This IE is defined in |
| | | | (10, 20, 40, 60, | TS 38.331 [18]. Unit: |
| | | | 90, 120, . . . ) | [minute]. |
| >>CHOICE Report Type | M | | | |
| >>>Periodical | | | NULL | |
| >>>Event Triggered | | | | |
| >>>>Event Trigger | M | | 9.3.1.180 | |
| Logged MDT | | | | |
| Configuration | | | | |
| >>Bluetooth Measurement | O | | 9.3.1.177 | |
| Configuration | | | | |
| >>WLAN Measurement | C | | 9.3.1.178 | |
| Configuration | | | | |
| >>Sensor Measurement | O | | 9.3.1.179 | |
| Configuration | | | | |
| >>Area Scope of | O | | 9.3.1.182 | |
| Neighbour Cells | | | | |
| Signaling Based MDT PLMN | O | | MDT PLMN List | |
| List | | | 9.3.1.168 | |
| Continuous MDT | 0 | | ENUMERATED | To configure |
| | | | (true, . . . ) | continuous MDT |
| | | | | operation across |
| | | | | RRC states |
| UE Selection Criteria | 0 | | OCTET STRING | Includes the UE- |
| | | | | CapabilityRAT- |
| | | | | ContainerList as |
| | | | | defined in |
| | | | | TS38.331. The IE is |
| | | | | used to select UEs |
| | | | | for MDT |
| | | | | configuration |

| Range bound | Explanation |
|---|---|
| maxnoofCellIDforMDT | Maximum no. of Cell ID subject for MDT |
| | scope. Value is 32. |
| maxnoofTAforMDT | Maximum no. of TA subject for MDT scope. |
| | Value is 8. |

| Condition | Explanation |
|---|---|
| C-ifM1 | This IE shall be present if the Measurements to Activate IE |
| | has the first bit set to “1”. |
| C-ifM4 | This IE shall be present if the Measurements to Activate IE |
| | has the third bit set to “1”. |
| C-ifM5 | This IE shall be present if the Measurements to Activate IE |
| | has the fourth bit set to “1”. |
| C-ifM6 | This IE shall be present if the Measurements to Activate IE |
| | has the fitth bit set to “1”. |
| C-ifM7 | This IE shall be present if the Measurements to Activate IE |
| | has the sixth bit set to “1”. |

In the example above, it is also shown how the Continuous MDT indication is used together with the UE Selection Criteria, which allows the selection of specific UEs with the indicated capabilities for the continuous MDT measurement collection process.

In a dependent embodiment, the Continuous MDT IE and the UE Selection Criteria IE may also be signalled as optional IEs within the MDT Configuration-EUTRA. Namely, the methods of embodiments herein may also be extended to other radio access technologies where MDT is used, such as LTE.

Another example of how the first indication may be received by the first radio access node 111 is shown below, where the Source NG-RAN Node to Target NG-RAN Node Transparent Container transmitted over the NG interface to the RAN is represented, with the addition of the flag indicating that the configuration is for continuous MDT.

### Source NG-RAN Node to Target NG-RAN Node Transparent Container

| | | | IE type and | | | Assigned |
|---|---|---|---|---|---|---|
| IE/Group Name | Presence | Range | reference | Semantics description | Criticality | Criticality |
| RRC Container | M | | OCTET | Includes the | — | |
| | | | STRING | HandoverPreparationInformation | | |
| | | | | message as defined in TS 38.331 | | |
| | | | | [18] if the target is a gNB. | | |
| | | | | Includes the | | |
| | | | | HandoverPreparationInformation | | |
| | | | | message as defined in TS 36.331 | | |
| | | | | [21] if the target is an ng-eNB. | | |
| PDU Session | | 0 . . . 1 | | For intra-system handovers in | — | |
| Resource | | | | NG-RAN. | | |
| Information | | | | | | |
| List | | | | | | |
| >PDU | | 1 . . . | | | — | |
| Session | | <maxnoofPDUSessions> | | | | |
| Resource | | | | | | |
| Information | | | | | | |
| Item | | | | | | |
| >>PDU | M | | 9.3.1.50 | | — | |
| Session ID | | | | | | |
| >>QoS Flow | | 1 | | | — | |
| Information | | | | | | |
| List | | | | | | |
| >>>QoS | | 1 . . . | | | — | |
| Flow | | <maxnoofQoSFlows> | | | | |
| Information | | | | | | |
| Item | | | | | | |
| >>>>QoS | M | | 9.3.1.51 | | — | |
| Flow | | | | | | |
| Identifier | | | | | | |
| >>>>DL | O | | 9.3.1.33 | | — | |
| Forwarding | | | | | | |
| >>>>UL | O | | 9.3.1.118 | | YES | ignore |
| Forwarding | | | | | | |
| >>>>Source | O | | Transport | Identifies the TNL address used | YES | ignore |
| Transport | | | Layer | by the sending node for direct | | |
| Layer | | | Address | data forwarding towards the | | |
| Address | | | 9.3.2.4 | target NG-RAN node | | |
| >>>>Source | O | | Transport | Identifies the TNL address used | YES | ignore |
| Node | | | Layer | by the source SN node for direct | | |
| Transport | | | Address | data forwarding towards the | | |
| Layer | | | 9.3.2.4 | target NG-RAN node | | |
| Address | | | | | | |
| >>DRBs to | O | | 9.3.1.34 | | — | |
| QoS Flows | | | | | | |
| Mapping List | | | | | | |
| E-RAB | | 0 . . . 1 | | For inter-system handovers to | — | |
| Information | | | | 5G. | | |
| List | | | | | | |
| >E-RAB | | 1 . . . | | | — | |
| Information | | <maxnoofE-RABs> | | | | |
| Item | | | | | | |
| >>E-RAB ID | M | | 9.3.2.3 | | — | |
| >>DL | O | | 9.3.1.33 | | — | |
| Forwarding | | | | | | |
| >>Source | O | | Transport | Identifies the TNL address used | YES | ignore |
| Transport | | | Layer | by the sending node for direct | | |
| Layer | | | Address | data forwarding towards the | | |
| Address | | | 9.3.2.4 | target NG-RAN node | | |
| >>Source | O | | Transport | Identifies the TNL address used | YES | ignore |
| Node | | | Layer | by the source SN node for direct | | |
| Transport | | | Address | data forwarding towards the | | |
| Layer | | | 9.3.2.4 | target NG-RAN node | | |
| Address | | | | | | |
| Target Cell ID | M | | NG-RAN | | — | |
| | | | CGI | | | |
| | | | 9.3.1.73 | | | |
| Index to RAT/ | O | | 9.3.1.61 | | — | |
| Frequency | | | | | | |
| Selection | | | | | | |
| Priority | | | | | | |
| UE History | M | | 9.3.1.95 | | — | |
| Information | | | | | | |
| SgNB UE | O | | 9.3.1.127 | Allocated at the Source en-gNB | — | |
| X2AP ID | | | | | | |
| UE History | O | | 9.3.1.166 | | YES | ignore |
| Information | | | | | | |
| from UE | | | | | | |
| Source Node | O | | 9.3.1.195 | Source SN ID | YES | ignore |
| ID | | | | | | |
| UE Context | O | | RAN UE | | YES | ignore |
| Reference at | | | NGAP ID | | | |
| Source | | | 9.3.3.2 | | | |
| MBS Active | | 0 . . . 1 | | | YES | ignore |
| Session | | | | | | |
| Information | | | | | | |
| Source to | | | | | | |
| Target List | | | | | | |
| >MBS Active | | 1 . . . | | | — | |
| Session | | <maxnoofMBSSessionsofUE> | | | | |
| Information | | | | | | |
| Source to | | | | | | |
| Target Item | | | | | | |
| >>MBS | M | | 9.3.1.206 | | — | |
| Session ID | | | | | | |
| >>MBS Area | O | | 9.3.1.207 | If included, this IE indicates the | — | |
| Session ID | | | | MBS Area Session ID of the UE | | |
| | | | | at the NG-RAN node from | | |
| | | | | which the UE context is | | |
| | | | | transferred | | |
| >>MBS | O | | 9.3.1.208 | Included if available in source | — | |
| Service Area | | | | NG-RAN node. | | |
| >>MBS QoS | M | | 9.3.1.236 | | — | |
| Flows To Be | | | | | | |
| Setup List | | | | | | |
| >>MBS | | 0 . . . 1 | | | — | |
| Mapping | | | | | | |
| and Data | | | | | | |
| Forwarding | | | | | | |
| Request List | | | | | | |
| >>>MBS | | 1 . . . | | | — | |
| Mapping | | <maxnoofMRBs> | | | | |
| and Data | | | | | | |
| Forwarding | | | | | | |
| Request Item | | | | | | |
| >>>>MRB | M | | 9.3.1.218 | Contains the MRB ID value | — | |
| ID | | | | allocated at the source NG-RAN | | |
| | | | | node. | | |
| >>>>MBS | | 1 . . . | | | — | |
| QoS Flow | | <maxnoofMBSQoSflows> | | | | |
| List | | | | | | |
| >>>>>MBS | M | | QoS Flow | | — | |
| QoS Flow | | | Identifier | | | |
| Identifier | | | 9.3.1.51 | | | |
| >>>>MRB | O | | 9.3.1.219 | The SN information of the last | — | |
| Progress | | | | packet which has already been | | |
| Information | | | | delivered for the MRB. | | |
| QMC | O | | 9.3.1.223 | Used for passing the QoE | YES | ignore |
| Configuration | | | | measurement information from | | |
| Information | | | | the source NG-RAN node to the | | |
| | | | | target NG-RAN node. | | |
| NGAP IE | | 0 . . . 1 | | | YES | ignore |
| Support | | | | | | |
| Information | | | | | | |
| Request List | | | | | | |
| >NGAP IE | | 1 . . . | | | — | |
| Support | | <maxnoofIESupportInfo> | | | | |
| Information | | | | | | |
| Request Item | | | | | | |
| >>NGAP | M | | 9.3.1.239 | | — | |
| Protocol IE-Id | | | | | | |
| Continuous | O | | ENUMERATED | This IE is used to configure | YES | ignore |
| MDT | | | (true, . . .) | Continuous MDT operation | | |

### Embodiments of the Wireless Communications Device (Group B Embodiments)

The solution proposed by embodiments disclosed herein comprises a method performed by the wireless communications device 121. The method comprises:

Receiving at least one MDT configuration and/or the first indication from the first radio access node 111.

Storing the first MDT configuration as well as the first indication in a memory of the wireless communications device 121. In a non-limiting example, the memory may be a UE access stratum memory such as VarLogMeasConfig or VarLogMeasReport according to the TS 38.331.

Performing a transition to the RRC IDLE/Inactive state and performing MDT measurements in RRC IDLE/Inactive state based on the first MDT configuration.

Performing a transition to the RRC_Connected mode to a cell belonging to a RAN node that may be any RAN node, here exemplified with the second radio access node 112.

Sending a signal including the first indication to the second radio access node 112 upon being connected to a cell belonging to or served by the second radio access node 112.

In a non-limiting example, the signal including the first indication may be an RRCSetupComplete message in NR RRC language or an RRCConnectionSetupComplete message in LTE RRC language.

In another non-limiting example, the signal including the first indication may be an RRC_XXX_complete message sent by the wireless communications device 121 optionally in response to an RRC message from the network, such as RRCResumeComplete, RRCReconfigurationComplete, etc.

In yet another non-limiting example, the signal including the first indication may be a UEAssistanceInformation signal.

In yet another non-limiting example, the signaling may comprise logged MDT measurements collected by the wireless communications device 121 while in RRC Idle or RRC Inactive and, as part of the logged measurements, it may include the first indication.

If the stored first indication at the wireless communications device 121 includes an area scope in which the continuity of the MDT measurement is valid, the wireless communications device 121 checks whether the continuity of the MDT measurement is applicable according to the configured area scope or not. If the wireless communications device 121 is camping/connected to a cell inside the configured area scope, the wireless communications device 121 sends the continuity indication to the network, otherwise the wireless communications device 121 does not need to send the continuity indication to the network.

If the stored first indication at the wireless communications device 121 includes a supervision timer (so-called continuity timer) value for which the continuity of the MDT measurement is valid within a certain period of time, the wireless communications device 121 checks whether the continuity of the MDT measurement is applicable according to the configured continuity timer value. If the continuity timer is running at the wireless communications device 121, the wireless communications device 121 sends the continuity indication to the network, otherwise (e.g., if the continuity timer has expired) the wireless communications device 121 does not need to send the continuity indication to the network.

In an example embodiment, the wireless communications device 121 starts the supervision timer upon receiving the first indication from the network node.

In another example embodiment, the wireless communications device 121 starts the supervision timer upon transition to IDLE/Inactive states.

In another example embodiment, the wireless communications device 121 starts the supervision timer upon starting MDT supervision timer, e.g., T330 timer.

If the stored first indication at the wireless communications device 121 includes an “extended continuity” value associated to one or more network optimization processes or AI/ML use cases, the wireless communications device 121 may store in memory the number of cells to which it has been recently connected and that were not affected by the network optimization processes or AI/ML use cases. The wireless communications device 121 may signal this value upon connecting to the new radio access node, which would indicate if the new cell is affected or not by the network optimization processes or AI/ML use cases. The number of not-affected cells may be updated accordingly.

### Second Radio Access Node Embodiments (Group C Embodiments)

Receiving a signal including the first indication (i.e., continuity indication) from the wireless communications device 121 connecting to the cell served by the second radio access node 112, or from the first radio access node 111, or from the core network node (AMF), e.g., as part of handover preparation signaling, Secondary Node addition/modification signaling, Retrieve UE context signaling, UE initial context signaling.

Determining an MDT configuration to continue performing MDT measurements based on the first indication. The MDT configuration may be determined based on the first indication received. Additionally, the MDT configuration to be configured at the wireless communications device 121 associated with the first indication may be derived by checking the MDT configurations received at the second radio access node 112. As an example, the second radio access node 112 may check the first indication received as part of the UE context and it may compare it with other indications and identifiers contained in the MDT configurations that the second radio access node 112 received from OAM. If the first indication matches with any of the equivalent identifiers in the MDT configurations at the second radio access node 112, then the second radio access node 112 selects that MDT configuration for the wireless communications device 121. In one embodiment, MDT configurations received at the second radio access node 112 contain a field that is an identifier, which is expressed in the same format as the first indication (assuming that the latter is represented as an identifier).

### Alternatively:

If the TR is used as continuity indication, the MDT configuration with the associated TR will be selected to continue performing MDT measurements for the wireless communications device 121.
If the TR+TRSR or Trace ID is used as continuity indication, the MDT configuration with the associated TR+TRSR or Trace ID will be selected to continue performing MDT measurements for the wireless communications device 121.
If the flag indicating the continuity of the MDT measurement is used as first indication, the second radio access node 112 may select any MDT configuration that is applicable to be performed for the wireless communications device 121.

Configuring the wireless communications device 121 and the RAN node (e.g., second radio access node 112 DU and/or second radio access node 112 CU-CP and/or CU-UP) to perform MDT measurements based on the selected MDT configuration, determined based on the first indication.

Collecting the MDT measurements according to the determined MDT configuration and forwarding the collected measurements to the TCE.

If the first indication includes an “extended continuity” value associated to one or more network optimization processes or AI/ML use cases and the wireless communications device 121 connects to a cell not affected by the said network optimization processes or AI/ML use cases, the second radio access node 112 may consider the number of not-affected cells to which the wireless communications device 121 has recently connected before configuring the wireless communications device 121 to continue performing MDT measurements. In case the MDT measurements are not stopped, the second radio access node 112 may indicate that the cell is not affected.

As one example of how the second radio access node 112 may receive from the first radio access node 111 an indication that the MDT configuration for the wireless communications device 121 is a continuous MDT configuration, the following changes to the XnAP interface are proposed.

### MDT Configuration-NR

The IE defines the MDT configuration parameters of NR.

| | | | IE type and | |
|---|---|---|---|---|
| IE/Group Name | Presence | Range | reference | Semantics description |
| MDT Activation | M | | ENUMERATED | |
| | | | (Immediate MDT | |
| | | | only, Logged | |
| | | | MDT only, | |
| | | | Immediate MDT | |
| | | | and Trace, . . . ) | |
| CHOICE Area | O | | | |
| Scope of MDT-NR | | | | |
| >Cell based | | | | |
| >>Cell ID List | | 1 .. | | |
| for MDT-NR | | <maxnoofCellIDforMDT> | | |
| >>>NR CGI | M | | 9.2.2.7 | |
| >TA based | | | | |
| >>TA List for | | 1 .. | | |
| MDT | | <maxnoofTAforMDT> | | |
| >>>TAC | M | | OCTET STRING | The TAI is derived using the current |
| | | | (SIZE (3)) | serving PLMN. |
| >TAI based | | | | |
| >>TAI List for | | 1 .. | | |
| MDT | | <maxnoofTAforMDT> | | |
| >>>TAI | M | | 9.2.3.20 | |
| CHOICE MDT | M | | | |
| Mode | | | | |
| >Immediate | | | | |
| MDT-NR | | | | |
| >>Measurements | M | | BITSTRING | Each position in the bitmap indicates |
| to Activate | | | (SIZE(8)) | a MDT measurement, as defined in |
| | | | | TS 37.320 [43]. |
| | | | | First Bit = M1, Second Bit= M2, |
| | | | | Fourth Bit = M4, Fifth Bit = M5, |
| | | | | Sixth Bit = logging of M1 from event |
| | | | | triggered measurement reports |
| | | | | according to existing RRM |
| | | | | configuration, |
| | | | | Seventh Bit = M6, Eighth Bit = M7. |
| | | | | Value “1” indicates “activate” and |
| | | | | value “0” indicates “do not activate”. |
| | | | | This version of the specification does |
| | | | | not use bits 3. |
| >>M1 | C-ifM1 | | 9.2.3.128 | |
| Configuration | | | | |
| >>M4 | C-ifM4 | | 9.2.3.129 | |
| Configuration | | | | |
| >>M5 | C-ifM5 | | 9.2.3.130 | |
| Configuration | | | | |
| >>MDT | O | | BITSTRING(SIZE(8)) | Each position in the bitmap |
| Location | | | | represents requested location |
| Information | | | | information as defined in TS 37.320 |
| | | | | [43]. |
| | | | | First Bit = GNSS |
| | | | | Other bits are reserved for future use |
| | | | | and are ignored if received. |
| | | | | Value “1” indicates “activate” and |
| | | | | value “0” indicates “do not activate”. |
| | | | | The eNB shall ignore the first bit |
| | | | | unless the Measurements to Activate |
| | | | | IE has the first bit or the sixth bit set |
| | | | | to “1”. |
| >>M6 | C-ifM6 | | 9.2.3.131 | |
| Configuration | | | | |
| >>M7 | C-ifM7 | | 9.2.3.132 | |
| Configuration | | | | |
| >>Bluetooth | O | | 9.2.3.11 | |
| Measurement | | | | |
| Configuration | | | | |
| >>WLAN | O | | 9.2.3.12 | |
| Measurement | | | | |
| Configuration | | | | |
| >>Sensor | O | | 9.2.3.136 | |
| Measurement | | | | |
| Configuration | | | | |
| >Logged MDT- | | | | |
| NR | | | | |
| >>Logging | M | | ENUMERATED | This IE is defined in TS 38.331 [10]. |
| interval | | | (ms320, ms640, | The value “infinity” represents one |
| | | | ms1280, ms2560, | shot logging, i.e., only one log per |
| | | | ms5120, ms10240, | event in the logged MDT report. |
| | | | ms20480, ms30720, | |
| | | | ms40960 and | |
| | | | ms61440, infinity) | |
| >>Logging | M | | ENUMERATED | This IE is defined in TS 38.331 [10]. |
| duration | | | (10, 20, 40, 60, | Unit: [minute]. |
| | | | 90, 120) | |
| >>CHOICE | M | | | |
| Report Type | | | | |
| >>>Periodical | | | | |
| >>>Event | | | | |
| Triggered | | | | |
| >>>>Logged | M | | 9.2.3.137 | |
| Event Trigger | | | | |
| Config | | | | |
| >>Bluetooth | O | | 9.2.3.134 | |
| Measurement | | | | |
| Configuration | | | | |
| >>WLAN | O | | 9.2.3.135 | |
| Measurement | | | | |
| Configuration | | | | |
| >>Sensor | O | | 9.2.3.136 | |
| Measurement | | | | |
| Configuration | | | | |
| >>Area Scope | O | | 9.2.3.140 | |
| of Neighbour | | | | |
| Cells | | | | |
| Signaling based | O | | MDT PLMN List | |
| MDT PLMN List | | | 9.2.3.133 | |
| Continuous MDT | O | | ENUMERATED | To configure continuous MDT |
| | | | (true, . . . ) | operation across RRC states |
| UE Selection | O | | OCTET STRING | Includes the UE-CapabilityRAT- |
| Criteria | | | | ContainerList as defined in |
| | | | | TS38.331. The IE is used to select |
| | | | | UEs for MDT configuration |

| Range bound | Explanation |
|---|---|
| maxnoofCellIDforMDT | Maximum no. of Cell ID subject for MDT |
| | scope. Value is 32 |
| maxnoofTAforMDT | Maximum no. of TA subject for MDT scope. |
| | Value is 8. |

| Condition | Explanation |
|---|---|
| ifM1 | This IE shall be present if the Measurements to Activate IE |
| | has the first bit set to “1”. |
| ifM4 | This IE shall be present if the Measurements to Activate IE |
| | has the fourth bit set to “1”. |
| ifM5 | This IE shall be present if the Measurements to Activate IE |
| | has the fifth bit set to “1”. |
| ifM6 | This IE shall be present if the Measurements to Activate IE |
| | has the seventh bit set to “1”. |
| ifM7 | This IE shall be present if the Measurements to Activate IE |
| | has the eighth bit set to “1”. |

In the example above it is also shown how the Continuous MDT indication is used together with the UE Selection Criteria, which allows the selection of specific UEs with the indicated capabilities for the continuous MDT measurement collection process.

In a dependent embodiment, the Continuous MDT IE and the UE Selection Criteria IE may also be signalled as optional IEs within the MDT Configuration-EUTRA. Namely, the methods of embodiments disclosed herein may also be extended to other radio access technologies where MDT is used, such as LTE.

The following proposed changes to the existing XnAP interface is another example of how the second radio access node 112 may receive from the first radio access node 111 the indication that the MDT configuration for the wireless communications device 121 is a continuous MDT configuration.

### Handover Request

| | | | IE type and | | | Assigned |
|---|---|---|---|---|---|---|
| IE/Group Name | Presence | Range | reference | Semantics description | Criticality | Criticality |
| Message Type | M | | 9.2.3.1 | | YES | reject |
| Source NG-RAN | M | | NG-RAN node | Allocated at the source NG-RAN | YES | reject |
| node UE XnAP ID | | | UE XnAP ID | node | | |
| reference | | | 9.2.3.16 | | | |
| Cause | M | | 9.2.3.2 | | YES | reject |
| Target Cell Global | M | | 9.2.3.25 | Includes either an E-UTRA CGI | YES | reject |
| ID | | | | or an NR CGI | | |
| GUAMI | M | | 9.2.3.24 | | YES | reject |
| UE Context | | 1 | | | YES | reject |
| Information | | | | | | |
| >NG-C UE | M | | AMF UE NGAP | Allocated at the AMF on the | — | |
| associated | | | ID 9.2.3.26 | source NG-C connection. | | |
| Signaling | | | | | | |
| reference | | | | | | |
| >Signaling TNL | M | | CP Transport | This IE indicates the AMF's IP | — | |
| association | | | Layer | address of the SCTP association | | |
| address at | | | Information | used at the source NG-C interface | | |
| source NG-C | | | 9.2.3.31 | instance. | | |
| side | | | | Note: If no UE TNLA binding | | |
| | | | | exists at the source NG-RAN | | |
| | | | | node, the source NG-RAN node | | |
| | | | | indicates the TNL association | | |
| | | | | address it would have selected if | | |
| | | | | it would have had to create a UE | | |
| | | | | TNLA binding. | | |
| >UE Security | M | | 9.2.3.49 | | — | |
| Capabilities | | | | | | |
| >AS Security | M | | 9.2.3.50 | | — | |
| Information | | | | | | |
| >Index to | O | | 9.2.3.23 | | — | |
| RAT/Frequency | | | | | | |
| Selection Priority | | | | | | |
| >UE Aggregate | M | | 9.2.3.17 | | — | |
| Maximum Bit | | | | | | |
| Rate | | | | | | |
| >PDU Session | | 1 | 9.2.1.1 | Similar to NG-C signaling, | — | |
| Resources To Be | | | | containing UL tunnel information | | |
| Setup List | | | | per PDU Session Resource; and | | |
| | | | | in addition, the source side QoS | | |
| | | | | flow ⇔ DRB mapping | | |
| >RRC Context | M | | OCTET STRING | Either includes the | — | |
| | | | | HandoverPreparationInformation | | |
| | | | | message as defined in subclause | | |
| | | | | 10.2.2. of TS 36.331 [14], or the | | |
| | | | | HandoverPreparationInformation- | | |
| | | | | NB message as defined in | | |
| | | | | subclause 10.6.2 of TS 36.331 | | |
| | | | | [14], if the target NG-RAN | | |
| | | | | node is an ng-eNB, or the | | |
| | | | | HandoverPreparationInformation | | |
| | | | | message as defined in subclause | | |
| | | | | 11.2.2 of TS 38.331 [10], if the | | |
| | | | | target NG-RAN node is a gNB. | | |
| >Location | O | | 9.2.3.47 | Includes the necessary parameters | — | |
| Reporting | | | | for location reporting. | | |
| Information | | | | | | |
| >Mobility | O | | 9.2.3.53 | | — | |
| Restriction List | | | | | | |
| >5GC Mobility | O | | 9.2.3.100 | | YES | ignore |
| Restriction List | | | | | | |
| Container | | | | | | |
| >NR UE Sidelink | O | | 9.2.3.107 | This IE applies only if the UE is | YES | ignore |
| Aggregate | | | | authorized for NR V2X services. | | |
| Maximum Bit Rate | | | | | | |
| >LTE UE Sidelink | O | | 9.2.3.108 | This IE applies only if the UE is | YES | ignore |
| Aggregate | | | | authorized for LTE V2X services. | | |
| Maximum Bit Rate | | | | | | |
| >Management | O | | MDT PLMN List | | YES | ignore |
| Based MDT | | | 9.2.3.133 | | | |
| PLMN List | | | | | | |
| >UE Radio | O | | 9.2.3.138 | | YES | reject |
| Capability ID | | | | | | |
| >MBS Session | O | | 9.2.1.36 | | YES | ignore |
| Information List | | | | | | |
| >5G ProSe UE | O | | NR UE Sidelink | This IE applies only if the UE is | YES | ignore |
| PC5 Aggregate | | | Aggregate | authorized for 5G ProSe services. | | |
| Maximum Bit | | | Maximum Bit | | | |
| Rate | | | Rate 9.2.3.107 | | | |
| >UE Slice | O | | 9.2.3.167 | | YES | ignore |
| Maximum Bit | | | | | | |
| Rate List | | | | | | |
| Trace Activation | O | | 9.2.3.55 | | YES | ignore |
| Masked IMEISV | O | | 9.2.3.32 | | YES | ignore |
| UE History | M | | 9.2.3.64 | | YES | ignore |
| Information | | | | | | |
| UE Context | O | | | | YES | ignore |
| Reference at the | | | | | | |
| S-NG-RAN node | | | | | | |
| >Global NG-RAN | M | | 9.2.2.3 | | — | |
| Node ID | | | | | | |
| >S-NG-RAN | M | | NG-RAN node | | — | |
| node UE XnAP | | | UE XnAP ID | | | |
| ID | | | 9.2.3.16 | | | |
| Conditional | O | | | | YES | reject |
| Handover | | | | | | |
| Information | | | | | | |
| Request | | | | | | |
| >CHO Trigger | M | | ENUMERATED | | — | |
| | | | (CHO-initiation, | | | |
| | | | CHO-replace, . . .) | | | |
| >Target NG-RAN | C- | | NG-RAN node | Allocated at the target NG-RAN | — | |
| node UE XnAP | ifCHOmod | | UE XnAP ID | node | | |
| ID | | | 9.2.3.16 | | | |
| >Estimated | O | | INTEGER | | | |
| Arrival Probability | | | (1 . . . 100) | | | |
| NR V2X Services | O | | 9.2.3.105 | | YES | ignore |
| Authorized | | | | | | |
| LTE V2X Services | O | | 9.2.3.106 | | YES | ignore |
| Authorized | | | | | | |
| PC5 QoS | O | | 9.2.3.109 | This IE applies only if the UE is | YES | ignore |
| Parameters | | | | authorized for NR V2X services. | | |
| Mobility | O | | BIT STRING | Information related to the | YES | ignore |
| Information | | | (SIZE (32)) | handover; the source NG-RAN | | |
| | | | | node provides it in order to | | |
| | | | | enable later analysis of the | | |
| | | | | conditions that led to a wrong | | |
| | | | | HO. | | |
| UE History | O | | 9.2.3.110 | | YES | ignore |
| Information from | | | | | | |
| the UE | | | | | | |
| IAB Node | O | | ENUMERATED | | YES | reject |
| Indication | | | (true, . . .) | | | |
| No PDU Session | O | | ENUMERATED | This IE applies only if the UE is | YES | ignore |
| Indication | | | (true, . . .) | an IAB-MT. | | |
| Time | O | | 9.2.3.153 | | YES | ignore |
| Synchronisation | | | | | | |
| Assistance | | | | | | |
| Information | | | | | | |
| QMC | O | | 9.2.3.156 | | YES | ignore |
| Configuration | | | | | | |
| Information | | | | | | |
| 5G ProSe | O | | 9.2.3.159 | | YES | ignore |
| Authorized | | | | | | |
| 5G ProSe PC5 | O | | 9.2.3.160 | This IE applies only if the UE is | YES | ignore |
| QoS Parameters | | | | authorized for 5G ProSe services. | | |
| Continuous MDT | O | | ENUMERATED | This IE is used to configure | YES | ignore |
| | | | (true, . . .) | Continuous MDT operation | | |

Embodiments concerning lack of the relevant MDT configuration at second radio access node 112 for continuity of measurements:

The second radio access node 112 upon receiving the first indication from the wireless communications device 121 may request other radio access nodes or the OAM/AMF to send an MDT configuration that is not available based on the first indication at the second radio access node 112. The method comprises: Determining that the first indication received by the wireless communications device 121 indicates an MDT configuration that is not available at the second radio access node 112.

Requesting other radio access nodes and/or OAM or AMF for the MDT configuration that is determined to be missing at the second radio access node 112.

The request may include an indication indicating the missing MDT configuration. The indication maybe a TR or TRSR or a combination of TR and TRSR. The indication may be any of the indicated versions of the first indication described herein.

Receiving the MDT configuration that is determined to be missing at the second radio access node 112 from other radio access nodes and/or OAM or AMF and that matches with the indication signalled from the second radio access node 112 to indicate that the MDT configuration is missing.

### OAM/AMF Node Embodiments (Group D Embodiments)

Possible actions of the OAM node 135 or the CN node 130 implementing the AMF are listed below.

Compiling one or more MDT configuration(s) including the first indication. The first indication indicates that the continuity of the MDT measurements across different RRC states as well as upon mobility is requested.

Sending one or more MDT configuration(s) to the first radio access node 111 including the first indication, indicating the continuity of the MDT measurements for the selected wireless communications device 121.

For the AMF, receiving an indication, such as the second indication, from the first radio access node 111 that a specific wireless communications device, such as the wireless communications device 121 has the first indication, e.g., that the wireless communications device 121 has been configured with the first indication, and storing the first indication information in the core network context for the wireless communications device 121, such as in the AMF UE context. Furthermore, including the first indication to the second radio access node 112, e.g., as part of INITIAL CONTEXT SETUP REQUEST message.

### Example Implementation of Embodiments Related to the Wireless Communications Device 121

In the below example implementation, the wireless communications device 121 is referred to as the UE and the first and second radio access nodes 111, 112 are referred to as NG-RAN.

### 5.3.3.4 Reception of the RRCSetup by the UE

The UE shall perform the following actions upon reception of the RRCSetup:
1> if the RRCSetup is received in response to an RRCReestablishmentRequest; or [text omitted]
   2> if the UE has logged measurements available for NR and if the RPLMN is included in plmn-IdentityList stored in VarLogMeasReport:
      3> include the logMeasAvailable in the RRCSetupComplete message;
      3> if Bluetooth measurement results are included in the logged measurements the UE has available for NR:
         4> include the logMeasAvailableBT in the RRCSetupComplete message;
      3> if WLAN measurement results are included in the logged measurements the UE has available for NR:
         4> include the logMeasAvailableWLAN in the RRCSetupComplete message;
   2> if the sigLoggedMeasType in VarLogMeasReport is included:
      3> if T330 timer is running and the logged measurements configuration is for NR:
         4> set sigLogMeasConfigAvailable to true in the RRCSetupComplete message;
      3> else:
         4> if the UE has logged measurements available for NR:
         5> set sigLogMeasConfigAvailable to false in the RRCSetupComplete message;

The below text in bold discloses three examples of procedural text describing what the wireless communications device 121 may do when establishing an RRC connection with a radio access node according to embodiments herein. A first example discloses signaling the continuity indication. Second and third examples respectively discloses signaling the continuity indication if the timer is running or in the allowed area. The second and third examples are related to embodiments herein mentioning “area scope” and “supervision timer”.
2> if the continuity Trace Reference and continuity TraceRecordingSessionRef are included in VarLogMeasReport:
   3> set continuity TraceReference and continuity Trace Recording SessionRef in the RRCSetupComplete message:
2> if the continuity Flag in VarLogMeasReport is included:
   3> set MDT-Continuity Flag to true in the RRCSetupComplete message;

In another non-limiting example:
2> if the continuity TraceReference and continuity Trace RecordingSessionRef are included in VarLogMeasReport:
   3> if continuity Timer timer is running:
      4> set continuity TraceReference and continuity Trace RecordingSessionRef in the RRCSetupComplete message;

In another non-limiting example:
2> if Continuity AreaConfiguration is included in VarLogMeasConfig; and
2> if the serving cell is part of the area indicated by ContinuityAreaConfiguration in VarLogMeasConfig:
   3> set continuityTraceReference and continuity Trace RecordingSessionRef in the RRCSetupComplete message;
2> if the UE has connection establishment failure or connection resume failure information available in VarConnEstFailReport or VarConnEstFailReportList and if the RPLMN is equal to plmn-Identity stored in VarConnEstFailReport or in at least one of the entries of VarConnEstFailReportList:
   3> include connEstFailInfoAvailable in the RRCSetupComplete message;
2> if the UE has radio link failure or handover failure information available in VarRLF-Report and if the RPLMN is included in plmn-IdentityList stored in VarRLF-Report, or
2> if the UE has radio link failure or handover failure information available in VarRLF-Report of TS 36.331 [10], and if the UE is capable of cross-RAT RLF reporting and if the RPLMN is included in plmn-IdentityList stored in VarRLF-Report of TS 36.331 [10]:
   3> include rlf-InfoAvailable in the RRCSetupComplete message;
2> if the UE has successful handover information available in VarSuccessHO-Report and if the RPLMN is included in plmn-IdentityList stored in VarSuccessHO-Report:
   3> include successHO-InfoAvailable in the RRCSetupComplete message;
2> if the UE supports storage of mobility history information and the UE has mobility history information available in VarMobilityHistoryReport:
   3> include the mobilityHistoryAvail in the RRCSetupComplete message;
2> if the UE supports uplink RRC message segmentation of UECapabilityInformation:
   3> may include the ul-RRC-Segmentation in the RRCSetupComplete message;
2> if the RRCSetup is received in response to an RRCResumeRequest, RRCResumeRequest1 or RRCSetupRequest:
   3> if speedStateReselectionPars is configured in the SIB2:
      4> include the mobilityState in the RRCSetupComplete message and set it to the mobility state (as specified in TS 38.304 [20]) of the UE just prior to entering RRC_CONNECTED state;
1> submit the RRCSetupComplete message to lower layers for transmission, upon which the procedure ends.

### Logged Measurements

### 5.5a.1 Logged Measurement Configuration

### 5.5a.1.1 General

See FIG. 6b. FIG. 6b illustrates how the UE may be configured with logged MDT measurements by signaling from the network, such as from NG-RAN. The purpose of this procedure is to configure the UE to perform logging of measurement results while in RRC_IDLE and RRC_INACTIVE. The procedure applies to logged measurements capable UEs that are in RRC_CONNECTED.
NOTE: NG-RAN may retrieve stored logged measurement information by means of the UE information procedure.

### 5.5a.1.2 Initiation

NG-RAN initiates the logged measurement configuration procedure to UE in RRC_CONNECTED by sending the LoggedMeasurementConfiguration message.

### 5.5a.1.3 Reception of the LoggedMeasurementConfiguration by the UE

Upon receiving the LoggedMeasurementConfiguration message the UE shall:
1> discard the logged measurement configuration as well as the logged measurement information as specified in 5.5a.2;
1> store the received loggingDuration, reportType and areaConfiguration, if included, in VarLogMeasConfig;
1> if the LoggedMeasurementConfiguration message includes plmn-IdentityList:
   2> set plmn-IdentityList in VarLogMeasReport to include the RPLMN as well as the PLMNs included in plmn-IdentityList;
1> else:
   2> set plmn-IdentityList in VarLogMeasReport to include the RPLMN;
1> store the received absoluteTimeInfo, traceReference, traceRecordingSessionRef, and tce-Id in VarLogMeasReport;
1> store the received bt-NameList, if included, in VarLogMeasConfig;
1> store the received wlan-NameList, if included, in VarLogMeasConfig;
1> store the received sensor-NameList, if included, in VarLogMeasConfig;
1> start timer T330 with the timer value set to the loggingDuration;
1> store the received sigLoggedMeasType, if included, in VarLogMeasReport;
1> store the received earlyMeasIndication, if included, in VarLogMeasConfig;
1> store the received continuity TraceReference, continuityTraceRecordingSessionRef, continuity Flag, continuityAreaConfiguration, continuityTimer, if included, in VarLogMeasConfig;
1> store the received continuity TraceReference, continuityTraceRecordingSessionRef, continuity Flag, continuityAreaConfiguration, continuityTimer, if included, in VarLogMeasReport;

The above bold text discloses two examples of what the wireless communications device 121 may do when receiving a configuration for (continuous) logged MDT from a radio access node. The above bold text relates to embodiments of the wireless communications device 121 for storing the first MDT configuration as well as the first indication in a memory of the wireless communications device 121. For example, in a non-limiting example, the memory may be a UE access stratum memory such as VarLogMeasConfig or VarLogMeasReport according to the TS 38.331.

### LoggedMeasurementConfiguration

The LoggedMeasurementConfiguration message is used to perform logging of measurement results while in RRC_IDLE or RRC_INACTIVE. It is used to transfer the logged measurement configuration for network performance optimisation.
Signaling radio bearer: SRB1
RLC-SAP: AM
Logical channel: DCCH
Direction: Network to UE, for example from radio access node to UE

LoggedMeasurementConfiguration message

-- ASN1START
-- TAG-LOGGEDMEASUREMENTCONFIGURATION-START

| | |
|---|---|
| LoggedMeasurementConfiguration-r16 ::= | SEQUENCE { |
| criticalExtensions | CHOICE { |

loggedMeasurementConfiguration-r16
LoggedMeasurementConfiguration-r16-IEs,

| | |
|---|---|
| criticalExtensionsFuture | SEQUENCE { } |

}
}

| | |
|---|---|
| LoggedMeasurementConfiguration-r16-IEs ::= | SEQUENCE { |
| traceReference-r16 | TraceReference-r16, |
| traceRecordingSessionRef-r16 | OCTET STRING (SIZE (2)), |
| tce-Id-r16 | OCTET STRING (SIZE (1)), |
| absoluteTimeInfo-r16 | AbsoluteTimeInfo-r16, |
| areaConfiguration-r16 | AreaConfiguration-r16 |

OPTIONAL, -- Need R

| | |
|---|---|
| plmn-IdentityList-r16 | PLMN-IdentityList2-r16 |

OPTIONAL, -- Need R

| bt-NameList-r16 | | SetupRelease {BT-NameList- |
|---|---|---|
| r16} | OPTIONAL, -- Need M | |
| wlan-NameList-r16 | | SetupRelease {WLAN- |
| NameList-r16} | OPTIONAL, -- Need M | |
| sensor-NameList-r16 | | SetupRelease {Sensor- |
| NameList-r16} | OPTIONAL, -- Need M | |

| | |
|---|---|
| loggingDuration-r16 | LoggingDuration-r16, |
| reportType | CHOICE { |

```
      periodical
LoggedPeriodicalReportConfig-r16,
      eventTriggered
LoggedEventTriggerConfig-r16,
      ...
    },
```

| | |
|---|---|
| lateNonCriticalExtension | OCTET STRING |

OPTIONAL,
nonCriticalExtension
LoggedMeasurementConfiguration-v1700-IEs OPTIONAL
}
LoggedMeasurementConfiguration-v1700-IEs ::= SEQUENCE {

| | |
|---|---|
| sigLoggedMeasType-r17 | ENUMERATED {true} |

OPTIONAL, -- Need R

| | |
|---|---|
| earlyMeasIndication-r17 | ENUMERATED {true} |

OPTIONAL, -- Need R

| | |
|---|---|
| areaConfiguration-v1700 | AreaConfiguration-v1700 |

OPTIONAL, --Need R
nonCriticalExtension

| | |
|---|---|
| LoggedMeasurementConfiguration-v1800 | OPTIONAL, |

}
LoggedMeasurementConfiguration-v1800-IEs ::= SEQUENCE {

| | |
|---|---|
| continuityTraceReference-18 | TraceReference-r16. |

OPTIONAL,

| | |
|---|---|
| continuityTraceRecordingSessionRef-r16 | OCTET STRING (SIZE (2)), |

OPTIONAL,

| | |
|---|---|
| continuityFlag-r18 | ENUMERATED {true} |

OPTIONAL,

| | |
|---|---|
| continuityAreaConfiguration-r18 | AreaConfiguration-v17 |

OPTIONAL,

| | |
|---|---|
| continuityTimer-r18 | ENUMERATED{ |

min10, min20, min40, min60, min90, min120, spare2, spare1}
OPTIONAL,

| | |
|---|---|
| nonCriticalExtension | SEQUENCE { } |

OPTIONAL
}

The bold text above illustrates some possible additions, according to some embodiments, to the ASN. 1 syntax defined by 3GPP TS 38.331. VarLogMeasConfig
The UE variable VarLogMeasConfig includes the configuration of the logging of measurements to be performed by the UE while in RRC_IDLE, RRC_INACTIVE, covering intra-frequency, inter-frequency and inter-RAT mobility related measurements. The UE performs logging of measurements only while in RRC_IDLE and RRC_INACTIVE.

VarLogMeasConfig UE variable

-- ASN1START
-- TAG-VARLOGMEASCONFIG-START
VarLogMeasConfig-r16-IEs ::= SEQUENCE {

| areaConfiguration-r16 | AreaConfiguration-r16 | OPTIONAL, |
|---|---|---|
| bt-NameList-r16 | BT-NameList-r16 | OPTIONAL, |
| wlan-NameList-r16 | WLAN-NameList-r16 | OPTIONAL, |
| sensor-NameList-r16 | Sensor-NameList-r16 | OPTIONAL, |
| loggingDuration-r16 | LoggingDuration-r16, | |
| reportType | CHOICE { | |
| periodical | LoggedPeriodicalReportConfig-r16, | |
| eventTriggered | LoggedEventTriggerConfig-r16 | |
| }, | | |
| sigLoggedMeasType-r17 | ENUMERATED {true} | OPTIONAL, |
| earlyMeasIndication-r17 | ENUMERATED {true} | OPTIONAL, |
| areaConfiguration-v1700 | AreaConfiguration-v1700 | OPTIONAL |

| | |
|---|---|
| continuityTraceReference-18 | TraceReference-r16. |

OPTIONAL,

| | |
|---|---|
| continuityTraceRecordingSessionRef-r16 | OCTET STRING (SIZE (2)), |

OPTIONAL,

| | |
|---|---|
| continuityFlag-r18 | ENUMERATED {true} |

OPTIONAL,

| | |
|---|---|
| continuityAreaConfiguration-r18 | AreaConfiguration-v17 |

OPTIONAL,

| | |
|---|---|
| continuityTimer-r18 | ENUMERATED{ |
| | min10, min20, min40, min60, min90, min120, |

spare2, spare1}
OPTIONAL,
}
-- TAG-VARLOGMEASCONFIG-STOP
-- ASN1STOP

The bold text above illustrates some possible additions, according to some embodiments, to the ASN. 1 syntax defined by 3GPP TS 38.331.

### VarLogMeasReport

The UE variable VarLogMeasReport includes the logged measurements information.

VarLogMeasReport UE variable

-- ASN1START
-- TAG-VARLOGMEASREPORT-START

| | |
|---|---|
| VarLogMeasReport-r16 ::= | SEQUENCE { |
| absoluteTimeInfo-r16 | AbsoluteTimeInfo-r16, |
| traceReference-r16 | TraceReference-r16, |
| traceRecordingSessionRef-r16 | OCTET STRING (SIZE (2)), |
| tce-Id-r16 | OCTET STRING (SIZE (1)), |
| logMeasInfoList-r16 | LogMeasInfoList-r16, |
| plmn-IdentityList-r16 | PLMN-IdentityList2-r16, |
| sigLoggedMeasType-r17 | ENUMERATED {true} |
| continuityTraceReference-18 | TraceReference-r16. |

OPTIONAL,

| | |
|---|---|
| continuityTraceRecordingSessionRef-r16 | OCTET STRING (SIZE (2)), |

OPTIONAL,

| | |
|---|---|
| continuityFlag-r18 | ENUMERATED {true} |

OPTIONAL,

| | |
|---|---|
| continuityAreaConfiguration-r18 | AreaConfiguration-v17 |

OPTIONAL,

| | |
|---|---|
| continuityTimer-r18 | ENUMERATED{ |
| | min10, min20, min40, min60, min90, min120, |

spare2, spare1}
OPTIONAL,
}

The bold text above illustrates some possible additions, according to some embodiments, to the ASN.1 syntax defined by 3GPP TS 38.331.

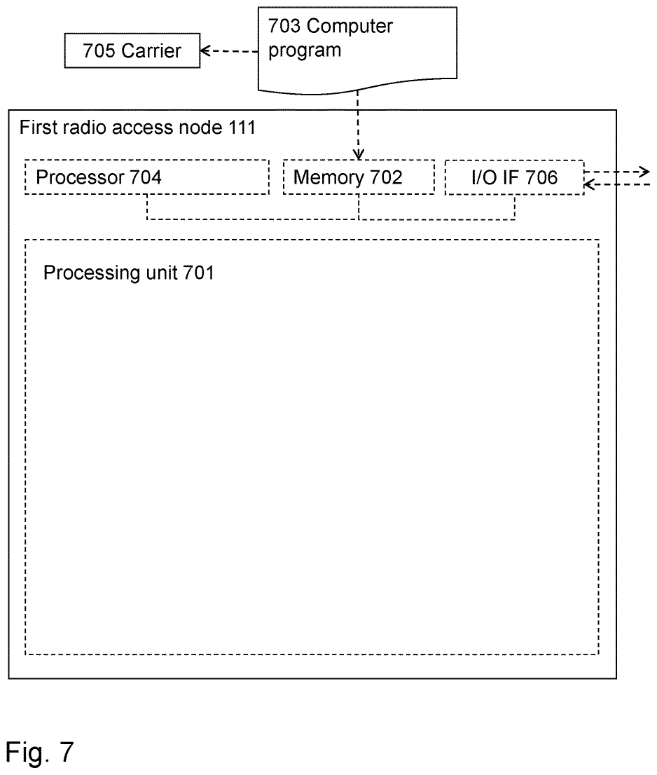

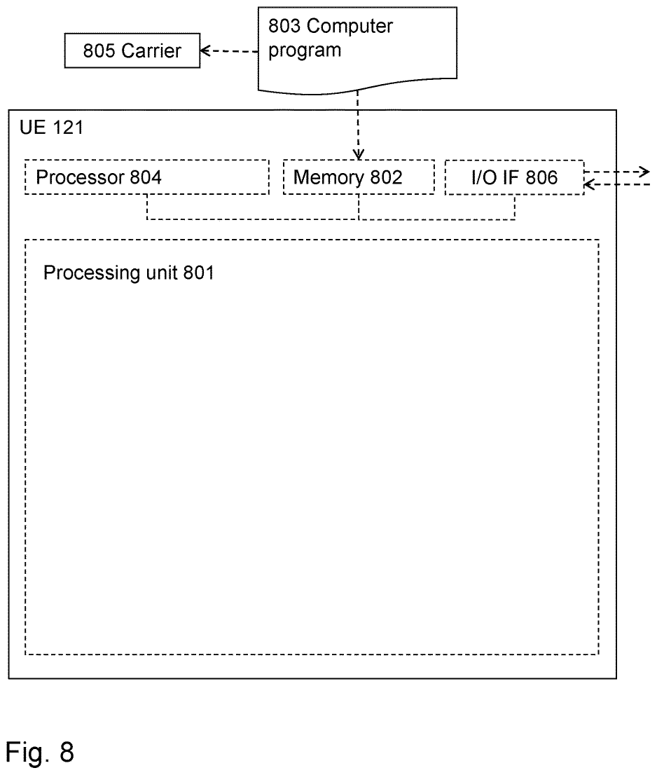

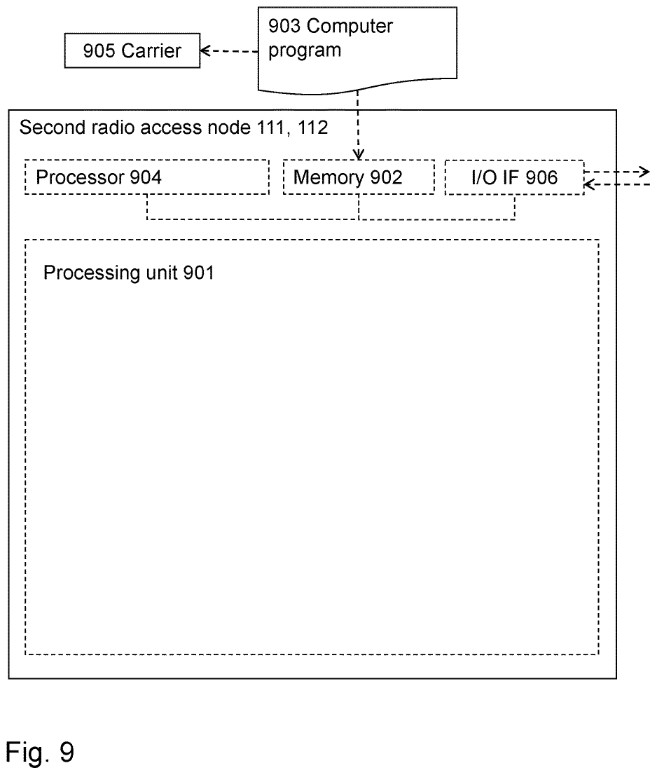

FIG. 6c shows an example of a network node, such as the AMF node 130 or the OAM node 135, FIG. 7 shows an example of the first radio access node 111, FIG. 8 shows an example of the wireless communications device 121 and FIG. 9 shows an example of the second radio access node 112.

The network node 111 may be adapted to perform the method actions of FIGS. 5a, 5aa and 6b, and some of the method actions of FIG. 6a above.

The first radio access node 111 is adapted for configuring the wireless communications device 121 with MDT measurements in the wireless communications network 100. The first radio access node 111 is further adapted to receive the first MDT configuration for MDT measurements for the wireless communications device 121.

The first radio access node 111 is further adapted to receive, together with or as part of the first MDT configuration, an indication of MDT continuity for the wireless communications device 121, wherein the indication of MDT continuity is an indication that continuity of the MDT configuration is requested for the wireless communications device 121.

The first radio access node 111 may be adapted to receive the indication of MDT continuity from any one of the OAM, node 135, the network node 130 implementing the AMF or another radio access node 112.

The first radio access node 111 is further adapted to configure the wireless communications device 121 to perform MDT measurements based on the first MDT configuration for MDT measurements and based on the indication of MDT continuity for the wireless communications device 121.

In some embodiments herein the first radio access node 111 is further adapted to receive the second MDT configuration for second MDT measurements and to configure the wireless communications device 121 to perform MDT measurements based on the second MDT configuration for MDT measurements and based on the indication of MDT continuity for the wireless communications device 121.

Upon mobility of the wireless communications device 121 in RRC_CONNECTED state, the first radio access node 111 may be further adapted to send the indication of MDT continuity for the wireless communications device 121 to the second radio access node 112 as part of a handover preparation.

Upon reception of the request from the second radio access node 112 to retrieve the context of the wireless communications device 121, first radio access node 111 may be further adapted to send the indication of MDT continuity for the wireless communications device 121 to the second radio access node 112 as part of the procedure to retrieve the context of the wireless communications device 121 from the first radio access node 111.

In some embodiments herein the first radio access node 111 is further adapted to select the wireless communications device 121 for continuous MDT measurements based on capabilities of the wireless communications device 121 for MDT measurements.

The wireless communications device 121 may be adapted to perform the method actions of FIGS. 5b and 6b, and some of the method actions of FIG. 6a above.

The wireless communications device 121 is adapted for configuring the wireless communications device 121 with MDT measurements in the wireless communications network 100. The wireless communications device 121 is further adapted to receive, from the first radio access node 111, an MDT configuration for MDT measurements for the wireless communications device 121. The MDT configuration includes an indication of MDT continuity for the wireless communications device 121. The indication of MDT continuity is an indication that continuity of the MDT measurements is requested.

The wireless communications device 121 is further adapted to perform the MDT measurements based on the MDT configuration including the indication of MDT continuity.

In some embodiments herein the wireless communications device 121 is further adapted to transmit the received indication of MDT continuity to the first radio access node 111 upon connection to the cell 115, 116 served by the first radio access node 111, or to the second radio access node 112 upon connection to the further cell 125, 126 served by the second radio access node 112.

The wireless communications device 121 may be further adapted to transmit the received indication of MDT continuity to the first radio access node 111 or the second radio access node 112 upon transitioning back to an RRC connected state.

When the received MDT configuration is the logged MDT configuration, then the MDT measurements may be performed in an RRC IDLE or inactive state of the wireless communications device 121.

The second radio access node 112 may be adapted to perform the method actions of FIG. 5c, and some of the method actions of FIG. 6a above.

The second radio access node 112 is adapted for configuring the wireless communications device 121 with MDT measurements in the wireless communications network 100. The second radio access node 112 is further adapted to receive an indication of MDT continuity for the wireless communications device 121. The indication of MDT continuity is an indication that continuity of the MDT measurements is requested.

The second radio access node 112 is further adapted to select an MDT configuration for MDT measurements to assign to the wireless communications device 121 based on the received indication of MDT continuity.

The second radio access node 112 is further adapted to configure the wireless communications device 121 to perform MDT measurements based on the selected MDT configuration

In some embodiments the indication of MDT continuity comprises the first identifier and then the second radio access node 112 may be further adapted to select the MDT configuration based on the received indication of MDT continuity by comparing the first identifier with the second identifier contained in an MDT configuration stored in the second radio access node 112 and select the MDT configuration containing the second identifier that matches the first identifier.

The indication of MDT continuity may be received upon handover preparation of the wireless communications device 121 from the first radio access node 111 or upon retrieval of the context of the wireless communications device 121.

In some embodiments the second radio access node 112 may be further adapted to determine that the indication of MDT continuity indicates an MDT configuration that is not available at the second radio access node 112. Then the second radio access node 112 may be further adapted to request another radio access node 111 and/or an Operations and Maintenance node 135 or the node 130 implementing an Access Management Function for the MDT configuration that is determined to be missing at the second radio access node 112. The request includes an indication indicating the missing MDT configuration.

The network node 130, 135 may be adapted to perform the method actions of FIG. 5d, and some of the method actions of FIG. 6a above.

The network node 130, 135 is adapted for configuring the wireless communications device 121 with MDT measurements in the wireless communications network 100. The network node 130, 135 is further adapted to transmit an MDT configuration for MDT measurements for the wireless communications device 121 to the radio access node 111.

The network node 130, 135 is further adapted to transmit, together with or as part of the MDT configuration, an indication that continuity of the MDT configuration is requested for the wireless communications device 121.

In some embodiments herein the network node 130, 135 implements an AMF. Then the network node 130, 135 may further be adapted to receive the second indication from the radio access node 111, 112 that the wireless communications device 121 has been configured with the first indication and further adapted to store the first indication information in the core network context for the wireless communications device 121, such as in the AMF UE context.

The AMF/OAM node 130, 135, the first radio access node 111, the wireless communications device 121 and the second radio access node 112 may comprise a respective input and output interface, IF, 606, 706, 806, 906 configured to communicate with each other, see FIGS. 6c-9. The input and output interface may comprise a wireless receiver (not shown) and a wireless transmitter (not shown).

The embodiments herein may be implemented through a respective processor or one or more processors, such as the respective processor 604, 704, 804, and 904, of a processing circuitry in the AMF/OAM node 130, 135, the first radio access node 111, the wireless communications device 121 and the second radio access node 112, and depicted in FIGS. 6c-9 together with computer program code for performing the functions and actions of the embodiments herein. The program code mentioned above may also be provided as a computer program product, for instance in the form of a data carrier carrying computer program code for performing the embodiments herein when being loaded into the respective AMF/OAM node 130, 135, first radio access node 111, wireless communications device 121 and the second radio access node 112. One such carrier may be in the form of a CD ROM disc. It is however feasible with other data carriers such as a memory stick. The computer program code may furthermore be provided as pure program code on a server and downloaded to the respective AMF/OAM node 130, 135, first radio access node 111 and wireless communications device 121, and second radio access node 112.

The AMF/OAM node 130, 135, the first radio access node 111, the wireless communications device 121 and the second radio access node 112 may further comprise a respective memory 602, 702, 802, and 902 comprising one or more memory units. The memory comprises instructions executable by the processor in AMF/OAM node 130, 135, the first radio access node 111, the wireless communications device 121 and the second radio access node 112.

Each respective memory 602, 702, 802 and 902 is arranged to be used to store e.g. information, data, configurations, and applications to perform the methods herein when being executed in the respective AMF/OAM node 130, 135, first radio access node 111, the wireless communications device 121 and second radio access node 112.

In some embodiments, a respective computer program 603, 703, 803 and 903 comprises instructions, which when executed by the at least one processor, cause the at least one processor of the respective AMF/OAM node 130, 135, first radio access node 111, wireless communications device 121 and second radio access node 112 to perform the actions above.

In some embodiments, a respective carrier 605, 705, 805 and 905 comprises the respective computer program, wherein the carrier is one of an electronic signal, an optical signal, an electromagnetic signal, a magnetic signal, an electric signal, a radio signal, a microwave signal, or a computer-readable storage medium.

Those skilled in the art will also appreciate that the units in the units described above may refer to a combination of analog and digital circuits, and/or one or more processors configured with software and/or firmware, e.g. stored in the respective AMF/OAM node 130, 135, first radio access node 111, the wireless communications device 121 and the second radio access node 112, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

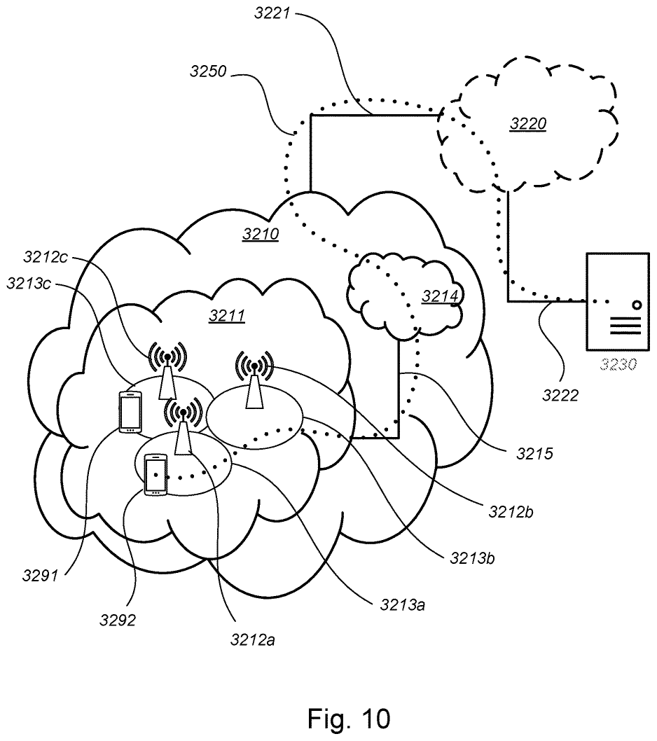

With reference to FIG. 10, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as the source and target access node 111, 112, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) such as a Non-AP STA 3291 located in coverage area 3213c is configured to wirelessly connect to, or be paged by, the corresponding base station 3212c. A second UE 3292 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 10 as a whole enables connectivity between one of the connected UEs 3291, 3292 such as e.g. the wireless communications device 121, and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

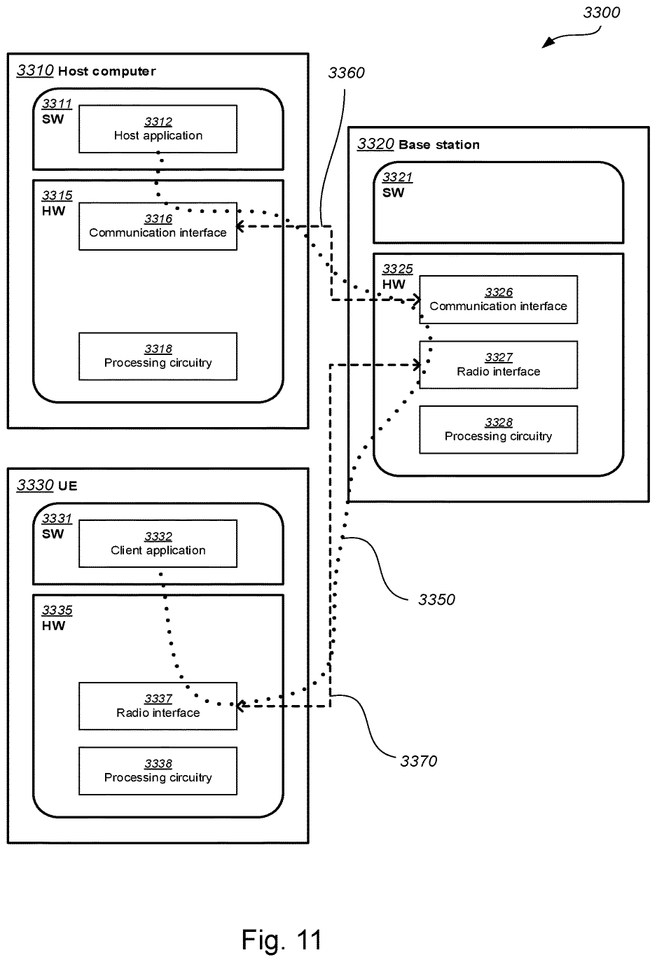

Example implementations, in accordance with an embodiment, of the UE, base station and host computer discussed in the preceding paragraphs will now be described with reference to FIG. 11. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350. The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 11) served by the base station 3320. The communication interface 3326 may be configured to facilitate a connection 3360 to the host computer 3310. The connection 3360 may be direct or it may pass through a core network (not shown in FIG. 11) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection. The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 11 may be identical to the host computer 3230, one of the base stations 3212a, 3212b, 3212c and one of the UEs 3291, 3292 of FIG. 10, respectively. This is to say, the inner workings of these entities may be as shown in FIG. 11 and independently, the surrounding network topology may be that of FIG. 10.

In FIG. 11, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the data rate, latency, power consumption and thereby provide benefits such as reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

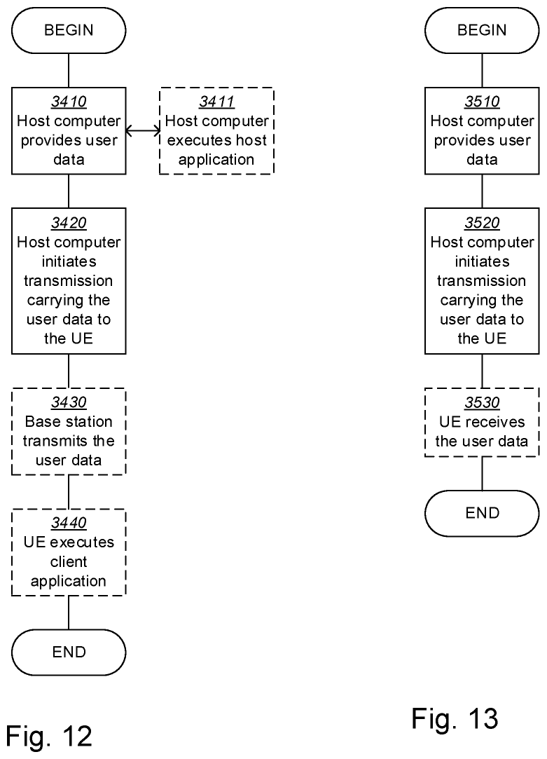

FIG. 12 is a flowchart illustrating a method implemented in a communication system, in accordance with one embodiment. The communication system includes a host computer, a base station such as a AP STA, and a UE such as a Non-AP STA which may be those described with reference to FIG. 10 and FIG. 11. For simplicity of the present disclosure, only drawing references to FIG. 12 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 13 is a flowchart illustrating a method implemented in a communication system, in accordance with one embodiment. The communication system includes a host computer, a base station such as a AP STA, and a UE such as a Non-AP STA which may be those described with reference to FIG. 10 and FIG. 11. For simplicity of the present disclosure, only drawing references to FIG. 13 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

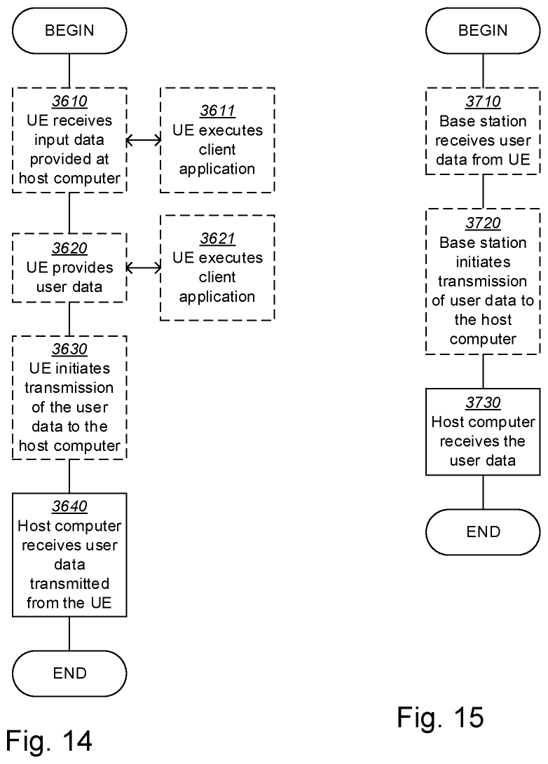

FIG. 14 is a flowchart illustrating a method implemented in a communication system, in accordance with one embodiment. The communication system includes a host computer, a base station such as a AP STA, and a UE such as a Non-AP STA which may be those described with reference to FIG. 10 and FIG. 11. For simplicity of the present disclosure, only drawing references to FIG. 14 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 15 is a flowchart illustrating a method implemented in a communication system, in accordance with one embodiment. The communication system includes a host computer, a base station such as a AP STA, and a UE such as a Non-AP STA which may be those described with reference to FIGS. 32 and 33. For simplicity of the present disclosure, only drawing references to FIG. 15 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

When using the word “comprise” or “comprising” it shall be interpreted as non-limiting, i.e., meaning “consist at least of”.

The embodiments herein are not limited to the above described preferred embodiments. Various alternatives, modifications and equivalents may be used.

### ABBREVIATIONS

Abbreviation Explanation

| | |
|---|---|
| DU | Distributed Unit |
| CU | Central Unit |
| CU-CP | Central Unit-Control Plane |
| CU-UP | Central Unit-User Plane |
| MDT | Minimization of Drive Test |
| UE | User Equipment (Wireless device in 3GPP systems) |
| NR | New Radio |
| LTE | Long Term Evolution |
| gNB | Base station in NR |
| eNB | Base station in LTE |
| RRC | Radio Resource Control |
| PDCP | Packet Data Convergence Protocol |
| RLC | Radio Link Control |
| MAC | Medium Access Control |
| MDT | Minimization of Drive Tests |
| MCE | Measurement Collection Entity |
| RAN | Radio Access Network |
| TCE | Trace Collection Entity |
| QoE | Quality of Experience |
| SRB | SIGNALING RADIO BEARER |

### NUMBERED EMBODIMENTS

1. A method, performed by a first radio access node 111, for configuring a wireless communications device 121 with an MDT configuration in a wireless communications network, the method comprises:
   Receiving a first MDT configuration;
   Receiving, together with or as part of the first MDT configuration, an indication that continuity of the MDT configuration is requested for the wireless communications device 121; and
   Configuring the wireless communications device 121 to perform MDT measurements based on the first configuration of MDT measurements and based on the indication of MDT continuity for the wireless communications device 121.
2. The method according to embodiment 1, wherein the first indication, when configured, tasks the first radio access node 111 to enable continuous MDT measurements across different RRC states and/or upon mobility from first radio access node 111 to a second radio access node 112.
3. The method according to embodiment 1, further comprising:
   Receiving a second MDT configuration; and
   Configuring the wireless communications device 121 to perform MDT measurements based on the second configuration of MDT measurements and based on the indication of MDT continuity for the wireless communications device 121.
4. A first radio access node 111, such as a gNB, in a wireless communications network 100, adapted for configuring a wireless communications device 121 with an MDT configuration in a wireless communications network 100. The first radio access node 111 is adapted to perform the method of embodiments 1-3.
5. A method for configuring a wireless communications device, such as a UE, with an MDT configuration in a wireless communications network, performed by the wireless communications device, the method comprises:
   receiving an MDT configuration including an indication that continuity of the MDT measurements is requested; and
   performing the MDT measurements based on the MDT configuration including the indication.
6. A wireless communications device, such as a UE, adapted for configuring the wireless communications device with an MDT configuration in a wireless communications network. The wireless communications device is adapted to perform the method of embodiment 5.
7. A method, performed by a second radio access node 112, for configuring a wireless communications device with an MDT configuration in a wireless communications network, the method comprises:
   receiving an indication that continuity of the MDT measurements is requested; and
   selecting a configuration to assign to the wireless communications device based on the received indication.
8. A second radio access node 112, such as a gNB, in a wireless communications network 100, adapted for configuring a wireless communications device 121 with an MDT configuration in a wireless communications network 100. The second radio access node 112 is adapted to perform the method of embodiment 7.
9. A method, performed by a network node, such as an AMF node 130 or an OAM node 135, for configuring a wireless communications device with an MDT configuration in a wireless communications network, the method comprises:
   transmitting a first MDT configuration to a radio access node;
   transmitting, together with or as part of the first MDT configuration, an indication that continuity of the MDT configuration is requested for the wireless communications device 121.
10. A network node, such as an AMF node 130 or an OAM node 135, in a wireless communications network 100, adapted for configuring a wireless communications device 121 with an MDT configuration in a wireless communications network 100. The AMF node 130 or the OAM node 135 is adapted to perform the method of embodiment 9.

1.-31. (canceled)

32. A method, performed by a first radio access node, for configuring a wireless communications device with Minimization of Drive Tests (MDT) measurements in a wireless communications network, the method comprises:
receiving a first MDT configuration for MDT measurements for the wireless communications device;
receiving, together with or as part of the first MDT configuration, an indication of MDT continuity for the wireless communications device, wherein the indication of MDT continuity is an indication that continuity of the MDT configuration is requested for the wireless communications device; and
configuring the wireless communications device to perform MDT measurements based on the first MDT configuration for MDT measurements and based on the indication of MDT continuity for the wireless communications device.

33. The method according to claim 32, wherein the indication of MDT continuity, when configured, tasks the first radio access node to enable continuous MDT measurements across different radio resource control (RRC) states and/or upon mobility of the wireless communications device from the first radio access node to a second radio access node.

34. The method according to claim 32, further comprising:
receiving a second MDT configuration for second MDT measurements; and
configuring the wireless communications device to perform MDT measurements based on the second MDT configuration for MDT measurements and based on the indication of MDT continuity for the wireless communications device.

35. The method according to claim 34, wherein the first MDT configuration is an immediate MDT configuration and the second MDT configuration is a logged MDT configuration or wherein the first MDT configuration is a logged MDT configuration and the second MDT configuration is an immediate MDT configuration.

36. The method according to claim 32, further comprising upon mobility of the wireless communications device in RRC_CONNECTED state, sending the indication of MDT continuity for the wireless communications device to a second radio access node as part of a handover preparation.

37. The method according to claim 32, further comprising, upon reception of a request from a second radio access node to retrieve a context of the wireless communications device, sending the indication of MDT continuity for the wireless communications device to the second radio access node as part of a procedure to retrieve the context of the wireless communications device from the first radio access node.

38. The method according to claim 32, further comprising selecting the wireless communications device for continuous MDT measurements based on capabilities of the wireless communications device for MDT measurements.

39. The method according to claim 32, wherein the indication of MDT continuity is:
a Trace Reference (TR) identifier, a Trace Recording Session Reference (TRSR) identifier, or both, associated to the first or second MDT configuration; or
a Trace ID value.

40. The method according to claim 32, wherein the indication of MDT continuity is received from any one of an Operations and Maintenance (OAM) node, a network node implementing an Access Management Function, or another radio access node.

41. The method according to claim 32, wherein the indication of MDT continuity includes any one or more of:
a. an area in which the continuity of the MDT measurements is requested and valid when the wireless communications device is camping in the area;
b. a time period during which continuity of the MDT measurements is valid;
c. a second MDT configuration to be used later;
d. a Quality of Experience (QoE) Reference ID or a Recording Session ID, indicating that continuity of the MDT measurements is required for a specific QoE measurement collection;
e. an indication of alignment between QoE and MDT, indicating that continuity of the MDT measurements is required for the purpose of aligning QoE measurements and MDT measurements;
f. a flag indicating that continuity of the MDT is for collecting data for machine learning;
g. one or more types of traffic or service for which the continuity of the MDT measurements is valid;
h. one or more network optimization processes or machine learning use cases, wherein the continuity of the MDT measurements is valid as long as the wireless communications device is camping on or being served by cells affected by the indicated network optimization processes or machine learning use cases; or
i. an extended continuity value X associated to each or some of the one or more network optimization processes or machine learning use cases, wherein the continuity of the MDT measurements is still valid in cells not affected by the indicated network optimization processes or AI/ML use cases as long as the wireless communications device has not been served by more than X consecutive not-affected cells.

42. The method according to claim 32, wherein the indication of MDT continuity is an identifier that identifies that an MDT process is continuous MDT and that the MDT configuration for the wireless communications device belongs to a specific MDT configuration class identified by the identifier.

43. A method, performed by a wireless communications device, for configuring the wireless communications device with Minimization of Drive Tests (MDT) measurements in a wireless communications network, the method comprises:
receiving, from a first radio access node, an MDT configuration for MDT measurements for the wireless communications device, including an indication of MDT continuity for the wireless communications device, wherein the indication of MDT continuity is an indication that continuity of the MDT measurements is requested; and
performing the MDT measurements based on the MDT configuration including the indication of MDT continuity.

44. The method according to claim 43, further comprising transmitting the received indication of MDT continuity to:
the first radio access node upon connection to a cell served by the first radio access node, or
a second radio access node upon connection to a further cell served by the second radio access node.

45. The method according to claim 44, wherein transmitting the received indication of MDT continuity to the first radio access node or the second radio access node is performed upon transitioning back to an RRC connected state.

46. The method according to claim 44, wherein the transmitted indication of MDT continuity is comprised in an RRC message.

47. The method according to claim 46, wherein the indication of MDT continuity includes any one or more of:
an area in which the continuity of the MDT measurements is requested and valid when the wireless communications device is camping in the area, and
a time period during which continuity of the MDT measurements is valid, and wherein transmitting the received indication of continuous MDT measurements to the first radio access node or the second radio access node is performed if the wireless communications device is camping in the area and/or if a time is within the time period during which continuity of the MDT measurements is valid.

48. The method according to claim 43, wherein the received MDT configuration is a logged MDT configuration, and wherein the MDT measurements are performed in an RRC IDLE or inactive state of the wireless communications device.

49. A method, performed by a second radio access node, for configuring a wireless communications device with Minimization of Drive Tests (MDT) measurements in a wireless communications network, the method comprises:
receiving an indication of MDT continuity for the wireless communications device, wherein the indication of MDT continuity is an indication that continuity of the MDT measurements is requested;
selecting an MDT configuration for MDT measurements to assign to the wireless communications device based on the received indication of MDT continuity; and
configuring the wireless communications device to perform MDT measurements based on the selected MDT configuration.

50. The method according to claim 49, wherein the indication of MDT continuity comprises a first identifier and wherein selecting the MDT configuration based on the received indication of MDT continuity comprises comparing the first identifier with a second identifier contained in an MDT configuration stored in the second radio access node and selecting the MDT configuration containing the second identifier that matches the first identifier.

51. A method, performed by a network node, for configuring a wireless communications device with Minimization of Drive Tests (MDT) measurements in a wireless communications network, the method comprises:
transmitting a first MDT configuration for MDT measurements for the wireless communications device to a radio access node; and
transmitting, together with or as part of the first MDT configuration, a first indication that continuity of the MDT configuration is requested for the wireless communications device.
